(19) United States
(12) Patent Application Publication
(10) Pub. No.: US 2026/0147411 A1
(43) Pub. Date: May 28, 2026

(54) SILENT COMMUNICATION, INTERACTION, AND/OR TRANSLATION

(71) Applicant: InnerVoice PBC, Berkeley, CA (US)

(72) Inventors: Aza Benjamin Blum Raskin, Berkeley, CA (US); Christopher Isaac Stone, Corte Madera, CA (US); Evan Howell Sharp, Berkeley, CA (US)

(73) Assignee: InnerVoice PBC, Berkeley, CA (US)

(21) Appl. No.: 19/396,921

(22) Filed: Nov. 21, 2025

Related U.S. Application Data
(60) Provisional application No. 63/724,099, filed on Nov. 22, 2024.

(51) Int. Cl. G06F 3/01

(52) U.S. Cl. CPC G06F 3/015

(57) ABSTRACT

A user interface system enables communication through inaudible speech by detecting physiological signals associated with inner voice communication. The system includes a wearable device positioned in, on, or around a user's ear, housing one or more sensor modalities such as electromyography (EMG) sensors for detecting muscle movements, functional near-infrared spectroscopy (fNIR) sensors for brain activity, and/or detection-and-ranging systems using sonar or radar for micro-deformations. Pre-processing modules condition the sensor data, which is then analyzed by one or more machine learning models to reconstruct the content of the user's inaudible communication and produce output representations. The system enables high-bandwidth natural language interaction without audible vocalization, maintaining privacy while supporting applications including AI assistant interaction, real-time translation, secure authentication, and inter-party communication.

### PRIORITY CLAIM

This application claims priority to U.S. Provisional Patent Application No. 63/724,099, filed Nov. 22, 2024, and titled “Silent Communication, Interaction, and/or Translation,” the contents of which are herein incorporated by reference in their entirety.

### BACKGROUND

Known communication interfaces typically rely primarily on voice and touch input, which present numerous challenges: voice input can be socially awkward, can leak secure information, and is impractical in noisy environments. Touch input, meanwhile, is often low bandwidth and inefficient. Thus, a need exists for an interface that maintains the high bandwidth of natural language while minimizing the social, security, and usability concerns inherent in known voice communication methods.

### BRIEF DESCRIPTION OF THE DRAWINGS

Various examples in accordance with the present disclosure will be described with reference to the drawings, in which:

FIG. 1 is a system block diagram of a user interface system, according to implementations of the present disclosure.

FIG. 2 is a block diagram illustrating the processing of one or more raw signals generated by the user interface system of FIG. 1, according to implementations of the present disclosure.

FIGS. 3A and 3B are block diagrams illustrating additional details of the pre-processing module(s) and machine learning model(s) illustrated of FIGS. 1 and 2, according to implementations of the present disclosure.

FIG. 4 is a block diagram of an example environment in which one or more user interface systems may be utilized, according to implementations of the present disclosure.

FIG. 5 is an block diagram illustrating additional components of the user assistance system of FIG. 4, according to implementations of the present disclosure.

FIG. 6 is an example user identity verification process, according to implementations of the present disclosure.

FIG. 7 is an example inner voice process, according to implementations of the present disclosure.

FIG. 8 is an example action execution process, according to implementations of the present disclosure.

FIG. 9 is an example inter-party communication process, according to implementations of the present disclosure.

FIG. 10 is an example user authenticity process, according to implementations of the present disclosure.

### DETAILED DESCRIPTION

Conventional communication interfaces rely predominantly on voice-based input (requiring audible speech) and/or touch-based input (such as typing or tapping on screens). These traditional interfaces present several significant limitations in modern usage contexts. Voice-based communication, while offering high-bandwidth natural language interaction, creates serious drawbacks. For example, it can be socially inappropriate or awkward in quiet public settings such as libraries, theaters, or meetings to use voice-based input, it inherently compromises privacy by broadcasting sensitive information to anyone within hearing distance, and it becomes unreliable or unusable in noisy environments where background sounds interfere with speech recognition. Touch-based input, on the other hand, suffers from fundamentally low bandwidth—typing or tapping is significantly slower than natural speech—and demands continuous visual attention and manual dexterity, making it inefficient for complex communication tasks. These limitations have created a persistent need for an interface technology that preserves the high-bandwidth advantages of natural language communication while eliminating the privacy, social, and environmental constraints inherent in audible speech and the efficiency constraints of touch-based input.

The disclosed implementations provide a user interface system that enables communication through what is referred to herein as “inner voice” or “inner speech”—that is, inaudible communication that includes subtle closed-mouth humming-style vocalizations, silently mimed speech (whether with closed or open mouth), and even purely imagined speech where a user thinks words without any external vocalization or visible mouth movement whatsoever. This silent communication capability offers a high-bandwidth, low-effort communication interface that functions effectively anywhere and anytime, regardless of ambient noise levels or social context. The system enables users to engage with artificial intelligence agents, other human individuals, computing devices, and various other recipients using only their inner voice, thereby maintaining the natural language efficiency of spoken communication while eliminating its drawbacks.

The disclosed implementations employ a multimodal sensor approach positioned in, on, and/or around the user's ear to detect and interpret the user's inner voice communications. Specifically, the system integrates multiple sensor modalities to capture comprehensive physiological data. Sensors may include any one or more types of sensors, such as optical/imaging type sensors, electrical sensors (ExG), acoustic sensors, electromagnetic sensors, motion sensors, and/or other forms and types of sensors. The sensor data streams from the one or more sensors may be processed, for example using one or more machine learning (ML) models, to determine and reconstruct the content of the user's inner voice communication and produce an output representation based on that reconstruction. The output representation may take various forms depending on the intended recipient and application, including text transcription, audio reconstruction of the user's voice, translated language output, or commands for device control.

The disclosed implementations provide substantial technical improvements over existing communication interfaces in multiple dimensions. First, by enabling natural language communication without audible vocalization, the system achieves high-bandwidth communication efficiency comparable to spoken speech while maintaining complete privacy and eliminating social awkwardness—a user can communicate silently in any environment without disturbing others or broadcasting sensitive information. Second, the multimodal sensor approach in a discrete, comfortable form factor similar to common wireless earbuds, makes the herein described user interface device practical for everyday use. Third, the system's ability to detect and interpret even purely imagined speech—where the user merely thinks words without any external manifestation—represents a significant advancement over prior speech. Fourth, the integration of brain imaging enables the system to capture not only the linguistic content of communication but also emotional context and user intent, supporting richer and more nuanced interactions. Finally, the unique combination of sensors enables continuous biometric authentication based on the user's individualized patterns of muscle movement, brain activity, and ear topology, providing inherent security features that verify user identity throughout communication sessions and detect potential spoofing attempts, deep fakes, or situations where a user is merely reading scripted content rather than authentically communicating their own thoughts.

The disclosed user interface device enables diverse applications across numerous domains. Users can interact with artificial intelligence agents, virtual assistants, and smart devices through natural language commands without speaking aloud, enabling seamless computing interaction in previously impractical contexts such as during meetings, in quiet public spaces, or while multitasking. The system supports real-time translation capabilities, where a user's inner voice communication in one language can be translated and output in another language for cross-language human communication. The continuous authentication capabilities enable secure transactions and sensitive operations based on verified user identity. The technology is particularly valuable for individuals with speech impairments or in situations where speech is impossible or inadvisable, providing an alternative high-bandwidth communication pathway. Moreover, the ability to detect the difference between a user's authentic inner voice and merely reading or repeating scripted content enables verification of authentic human communication in an era where artificial intelligence can generate convincing speech, addressing emerging challenges in human-AI interaction and digital security.

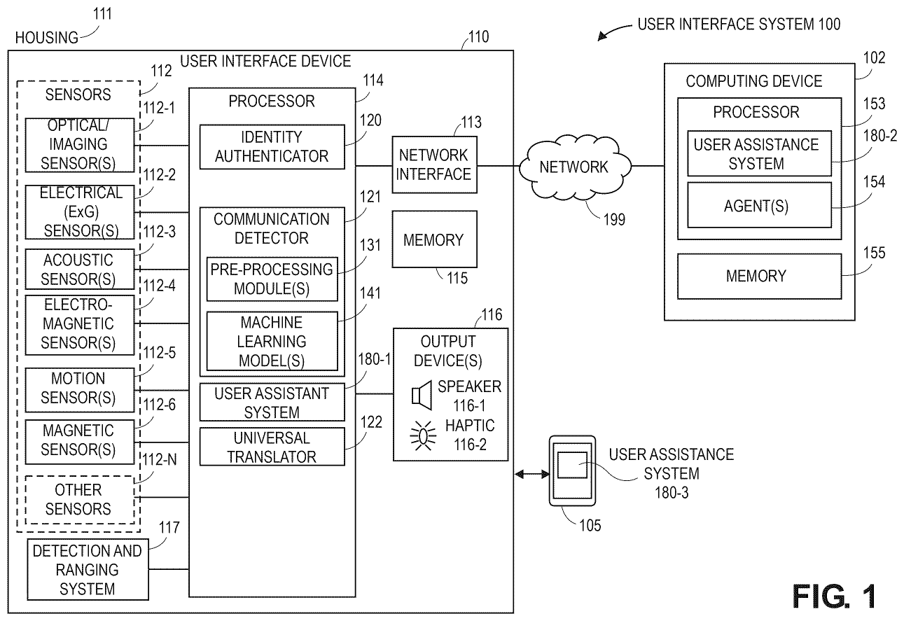

FIG. 1 is a system block diagram of a user interface system 100, according to implementations of the present disclosure.

As shown in FIG. 1, the user interface system 100 includes a user-interface device 110, a user device 105, and a computing device 102 that are connected together by a network 199.

The user-interface device 110 includes a housing 111 that has a form factor appropriate for positioning on, in and/or around an ear of a user. In some examples, the user-interface device 110 may include a single housing 111 that is positioned on, in, and/or around one ear of the user. In other examples, the user-interface device may include a pair of housings 111, one for each ear such that the user wears the user-interface device 110 on, in, and/or around both ears. The housing 111 can be formed of a plastic material or other suitable material and is sized and shaped to fit partially within the ear canal and/or partially around, on, or over the top of the ear. The housing 111 can be further sized and shaped to position the various sensors in locations appropriate for the sensors to collect the relevant data. In some implementations, the housing 111 is sized and shaped to be positioned at least partially within an ear canal of the user. In other implementations, the housing 111 is sized and shaped to be positioned at least partially around an outer portion of an ear of the user. In implementations in which the user-interface device 110 includes two housings 111 (one for each ear) components, sensors, etc., of the user-interface device 110 may be distributed between the housings 111 and/or included in each housing 111. Likewise, the components, sensors, etc., of the two housings may be configured to communicate through wired and/or wireless connectivity as part of the single user-interface device 110.

The housing 111 has an interior volume within which several key components are disposed. A processor 114 (or multiple processors), a network interface 113, an array of sensors 112, and memory 115 are disposed within the interior volume of the housing 111. The processor 114 can be, for example, a hardware-based integrated circuit (IC), or any other suitable processing device configured to run and/or execute a set of instructions or code stored in the memory 115. For example, the processor 114 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a graphics processing unit (GPU), a programmable logic controller (PLC), or any other suitable processing device. In some implementations, the processor 114 can include a plurality of parallelly arranged processors.

The memory 115 can be, for example, a random-access memory (RAM), a memory buffer, a hard drive, a read-only memory (ROM), an erasable programmable read-only memory (EPROM), and/or the like. The memory 115 can store, for example, one or more software modules and/or code that can include instructions to cause the processor 114 to perform one or more processes, functions, and/or the like. In some implementations, the memory 115 can be a portable memory that can be operatively coupled to the processor 114. In some instances, the memory 115 can be remotely operatively coupled with the processor 114, for example, via the network interface 113.

The network interface 113 enables communication between the user-interface device 110, the user device 105, and/or the computing device 102 via the network 199. The network interface 113 can be configured to allow data to be exchanged between the user-interface device 110, the user device 105, and/or the computing device 102 through various types of wired or wireless communication protocols.

The user-interface device 110 includes sensors 112 that work in combination to detect the user's inaudible communication. The optical/imaging sensor(s) 112-1 are coupled to the processor 114 and configured to capture visual and optical data. The optical/imaging sensor(s) 112-1 can include high-speed cameras, near-field infrared sensors, interferometry sensors, etc. The high-speed cameras may be positioned to track minute movements inside the ear based on unique patterns or markers within the ear. In some implementations, an in-ear camera can be oriented with a field-of-view toward the ear drum to capture fine-grained motion data during inner voice communication. The near-field infrared sensors may be used to detect changes or deformations in the shape of the inner ear that occur during inaudible speech of the user that may be used to determine the inner voice communication. The optical/imaging sensor(s) 112-1 can also include interferometry sensors configured to detect micro-deformations based on changes in light wave patterns. In some implementations, the optical/imaging sensor(s) 112-1 can include an exterior-facing camera to capture image data of the environment surrounding the user. In some examples, the exterior-facing camera includes a wide-angle lens or is configured as a 360-degree field of view camera. Data from the exterior-facing camera may be used to enable context-aware assistance, such as identifying objects in the environment, understanding settings that boost creativity, sharing a visual perspective during a conversation with another person, or being able to search for items in a user's temporal-spatial history (e.g., where are my car keys).

The electrical (ExG) sensor(s) 112-2 are coupled to the processor 114 and configured to detect electrical signals from the user's body. The electrical (ExG) sensor(s) 112-2 can include electromyography (EMG) sensors, electroencephalography (EEG) sensors, electrooculography (EOG) sensors, electrodermal sensors, magnetoencephalography (MEG) sensors, etc. The EMG sensors may be configured to detect micro-movements of at least one of a jaw, a tongue, or vocal tract muscles of the user during an inaudible communication of the user, to produce EMG sensor data. Likewise, the EMG sensors and/or EOG sensors may detect eye movement of the user. Further, the EMG sensors can detect the micro-signals generated by the brain's proprioceptive commands to the muscles involved in speech. These signals can be interpreted to reconstruct the user's intended communication. The EMG sensors are particularly effective at capturing muscle movements that occur even during imagined speech due to motor planning signals sent by the brain. The electrical (ExG) sensor(s) 112-2 can also include in-ear electroencephalography (EEG) sensors configured to record electrical activity from a brain of the user. The EEG sensors can detect the neural signals (efference copy and corollary discharge signals) that are generated when a user thinks about speaking, enabling detection of purely imagined speech.

The acoustic sensor(s) 112-3 are coupled to the processor 114 and configured to capture acoustic signals. The acoustic sensor(s) 112-3 can include microelectromechanical systems (MEMS) microphones, sound navigation and ranging (SONAR) sensors, otoacoustic emissions sensors, ultrasound sensors, etc. MEMS microphones may be configured to capture movements related to jaw and tongue actions. Such movements may include jaw movements, tongue movements, inner ear movements, etc. SONAR sensors may also be used to detect fine-grained motion in and/or around the ear of the user. Otoacoustic emission sensors may be configured to detect changes or deformations in the ear during inaudible communications. The ultrasound sensor(s) may be configured to capture detailed inner ear movements related to the inaudible communication by transmitting and receiving high-frequency sound waves that reflect off internal structures of the ear. In some implementations, the ultrasound sensor(s) may be further configured to perform transcranial focused ultrasound neuromodulation by delivering low-intensity focused ultrasound (LIFU) to targeted neural regions of the brain of the user. This neuromodulation capability enables bidirectional communication with the nervous system of the user—not only detecting neural signals associated with inner voice communication but also delivering controlled acoustic energy to modulate neural activity. The focused ultrasound can temporarily alter neuronal membrane permeability, influence ion channel activity, and modulate synaptic transmission in specific brain regions, enabling applications such as mood regulation, cognitive enhancement, attention focusing, or reduction of communication-related anxiety. The system may determine appropriate neuromodulation parameters based on the user's detected emotional state from the fNIR sensors 112-4 and EEG sensors 112-2, creating a closed-loop system that both interprets the user's inner voice and emotional state while providing targeted neural feedback to enhance communication effectiveness, reduce stress, or optimize cognitive performance during interactions. The acoustic signals from the acoustic sensor(s) 112-3 can provide information about the subtle movements and changes occurring during inner voice generation.

The electromagnetic sensor(s) 112-4 are coupled to the processor 114 and configured to detect electromagnetic signals. The electromagnetic sensor(s) 112-4 can include functional near-infrared spectroscopy (fNIR) sensors, radio detection and ranging (RADAR) sensors, near-infrared (NIR) sensors, etc. fNIR sensors may be configured to detect image data of a brain of the user. For example, the fNIR may detect image data of a temporal lobe of the brain of the user during the inaudible communication of the user, to produce fNIR sensor data. The fNIR sensors can generate electromagnetic signal data of the brain, such as the temporal lobe of the brain, providing insights into language processing, emotional responses, memory formation, etc. The temporal lobe is associated with at least one of language processing, emotional responses, or memory formation, which enhances the personalization and quality of interactions. The fNIR sensors enable the system to capture not only the linguistic content of communication but also emotional context and user intent, supporting richer and more nuanced interactions. RADAR sensors may be used to detect micro-deformations in or around the ear of the user using electromagnetic signals. NIR sensors may be configured to detect other user biometrics such as heart rate, blood pressure, glucose, etc.

The motion sensor(s) 112-5 are coupled to the processor 114 and configured to detect head movements and orientation of the user. The motion sensor(s) 112-5 can include an accelerometer, gyroscope, etc. Data received from the motion sensor(s) 112-5 may be received by the processor 114 to detect or determine intent or other input of the user. For example, in response to an audible output through a speaker 116-1 of the determined content of the inner voice, the motion sensor(s) 112-5 may detect a head movement of the user confirming (nodding of head up and down) or rejecting (rotating of head left and right) the determined content of the inner voice.

The magnetic sensor(s) 112-6 are coupled to the processor 114 and configured to detect magnetic fields generated by the user's body. The magnetic sensor(s) 112-6 can include superconducting quantum interference devices (SQUIDs), magnetoencephalography (MEG) sensors, magnetometers, etc. SQUID sensors may be configured to detect magnetic fields associated with neural activity in the brain of the user to determine subtle patterns during inaudible communication. MEG sensors may be configured to measure magnetic fields produced by electrical currents in neurons, offering enhanced spatial resolution for localizing brain activity during inner voice generation. The magnetic sensor(s) 112-6 can detect magnetic signatures that occur during speech planning and execution, complementing the electrical signals captured by the electrical (ExG) sensors 112-2.

The other sensor(s) 112-N represent additional sensor modalities that can be included to enhance the functionality of the user-interface device 110 and provide additional data streams for improved detection and interpretation of the user's inner voice. The other sensor(s) 112-N can include any other types of sensors not specifically categorized above that may be beneficial for detecting physiological signals associated with inner voice communication.

As shown in FIG. 1, the user-interface device 110 may also include a detection and ranging system 117. The detection and ranging system 117 is coupled to the processor 114 and configured to receive and process sensor data from one or more of the sensors 112 to detect, for example, micro-deformations inside an ear of the user during the inaudible communication of the user, and to produce detection-and-ranging data.

For example, the detection and ranging system 117 is operable to use sensor data from the acoustic sensor(s) 112-3 (such as SONAR and ultrasound sensor data) and/or the electromagnetic sensor(s) 112-4 (such as RADAR sensor data) to analyze and map the micro-deformations caused by jaw, tongue, and/or ear movements during mimed speech and inner voice generation. By processing these sensor signals, the detection and ranging system 117 enables real-time ear topology mapping. The micro-deformations create measurable changes in the ear's internal topology that can be detected and mapped in real-time through the analysis performed by the detection and ranging system 117. This functional capability works in coordination with the data collected by sensors 112 to provide a complete and intuitive interface for interacting with both AI agents and real people.

The user-interface device 110 may also include one or more output device(s) 116. In some implementations, the output device(s) 116 include a speaker 116-1 that may be at least partially disposed within or attached to the housing 111. The speaker 116-1 can be configured to provide audible feedback to the user. The processor 114 may be configured to provide feedback, recommendations, communication, etc., to the user through the speaker 116-1. For example, upon determination of the content of the detected inner voice, the processor 114 may provide that content back to the user in an audible format (e.g., speech) that is output by the speaker 116-1. When the system makes recommendations to the user, the system can output such recommendations in audible form through the speaker 116-1 so the user can hear the recommendation.

In some implementations, the output device(s) 116 include a haptic device 116-2. The haptic device 116-2 can be configured to provide tactile feedback to the user. The system may use the haptic device 116-2 to provide haptic feedback to the user, such as a defined pattern of haptic output confirming detection of a confirmation or indicating other information to the user.

In some implementations the user may have access to additional output devices, such as user device 105. The user device may be, for example, a smartphone, tablet, laptop, and/or other device operatively coupled to the user interface device 110. In such a configuration, the user interface device 110 may provide content to the user via the user device 105 rather than, or in addition to, through the user-interface device 110. For example, a user device 105 with a display may be used to provide visual feedback to the user. In sum, the system not only receives data from the user via the user-interface device 110 (e.g., sensor data), but the system can send data to the user, for example via the user-interface device 110 and/or another user device 105. Still further, in some implementations, one or more processing or software components, such as ML models may operate on the user interface device 110, the computing device 102, and/or the user device 105.

The processor 114 of the user-interface device 110 includes several functional components that process the sensor data and enable the various capabilities discussed herein. For example, the processor may be configured to execute program instructions that perform functions of an identity authenticator 120, a communication detector 121, some or all portions of a user assistant system 180-1, and/or a universal translator 122.

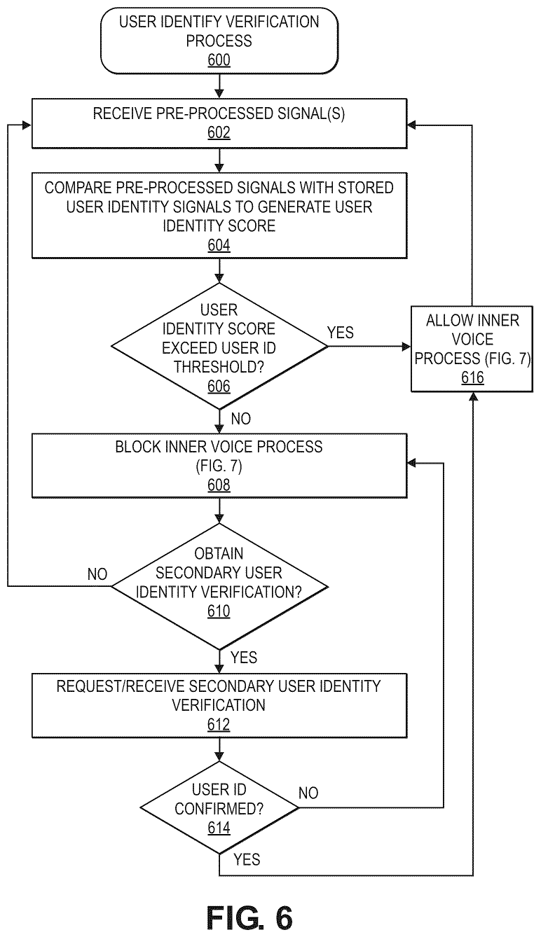

The identity authenticator 120 is configured to analyze patterns within the sensor data corresponding to characteristics unique to the user, compare the patterns with stored profile data associated with the user, and generate, based at least in part on the comparison, an authentication result indicating whether the user is authenticated. The unique combination of sensors 112 and detection and ranging system 117 enables continuous biometric authentication based on the user's individualized patterns of muscle movement, brain activity, and ear topology, providing inherent security features that verify user identity throughout communication sessions and detect potential spoofing attempts, deep fakes, or situations where a user is merely reading scripted content rather than authentically communicating their own thoughts. As discussed further with respect to FIG. 6, the identity authenticator 120 performs a user identity verification process.

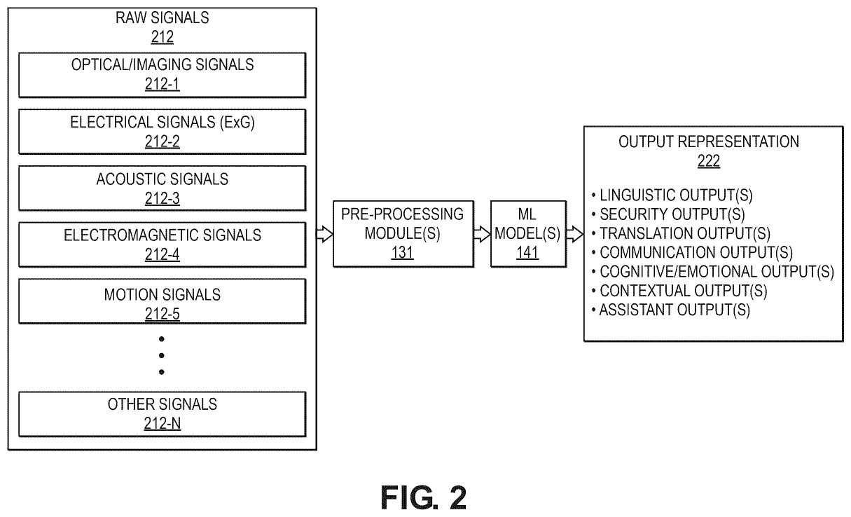

The communication detector 121 is operable to interpret the user's inner voice. The communication detector 121 includes a pre-processing module(s) 131 and a machine learning (ML) model(s) 141, as discussed further herein. The pre-processing module(s) 131 is operable to receive the sensor data from each of the optical/imaging sensor(s) 112-1, the electrical (ExG) sensor(s) 112-2, the acoustic sensor(s) 112-3, the electromagnetic sensor(s) 112-4, the motion sensor(s) 112-5, the magnetic sensors 112-6, the other sensor(s) 112-N, and the detection and ranging system 117, and then perform processing on that sensor data for later use. The pre-processing module(s) 131 can receive each data stream and perform pre-processing steps such as noise reduction, motion artifact removal, filtering, etc. This allows the data to be clean and accurate before input into the ML model(s) 141. These pre-processing steps can help to enhance the reliability of the interpretation, especially in noisy or dynamic environments. The pre-processing module(s) 131 can process the sensor data to put the sensor data in a format more effective and/or compatible for use by the ML model(s) 141, and produce pre-processed sensor data. In some implementations, the pre-processing module(s) 131 is disposed within the housing 111 of the user-interface device 110. In other implementations, the pre-processing module(s) may operate on the user device 105 and/or the computing device 102. In such configurations, the raw signal data generated by the sensors are transmitted from the user-interface device 110 to the other device(s) for pre-processing. As discussed further with respect to FIG. 2, the pre-processing module(s) 131 receives raw signals 212 (including optical/imaging signals 212-1, electrical signals (ExG) 212-2, acoustic signals 212-3, electromagnetic signals 212-4, motion signals 212-5, and other signals 212-N) and processes them for use by the ML model(s) 141.

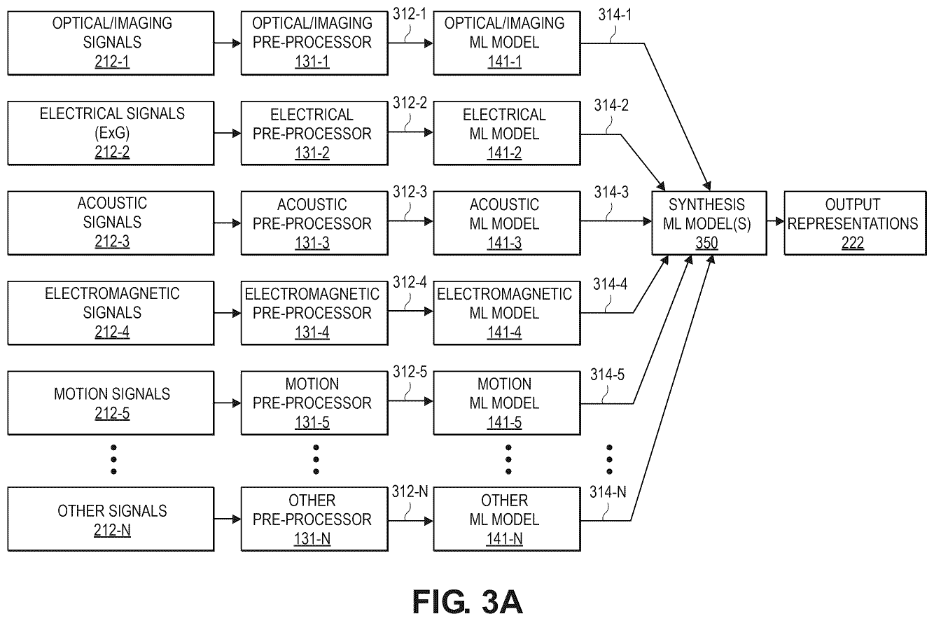

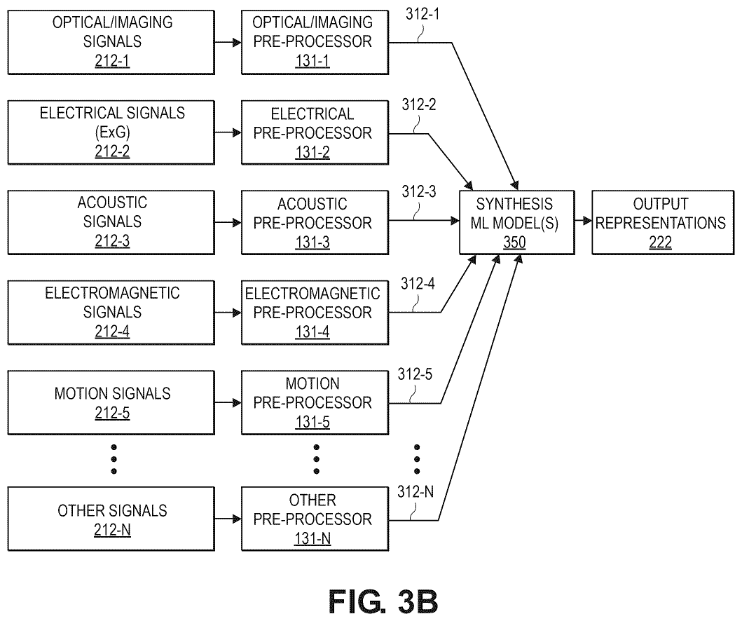

The ML model(s) 141 is communicatively coupled with the pre-processing module(s) 131 and is configured to receive as input the pre-processed sensor data and produce an output representation of a content of the inaudible communication of the user. The ML model(s) 141 can perform sensor fusion and other processing to perform the detection of user communications as described herein. The ML model(s) 141 can be configured in a variety of ways. For example, the ML model(s) 141 can include multiple separate ML models (also referred to as sensor-specific ML models), each of which is used to encode a sensor's input individually before passing the outputs to a synthesis model. Alternatively, the ML model(s) 141 can be a single ML model that processes all sensor inputs collectively. The choice of configuration depends on the use case and allows for flexibility in how the ML model(s) 141 processes and synthesizes the data during inference. As discussed further with respect to FIGS. 3A and 3B, the ML model(s) 141 may include a plurality of sensor-specific ML models (such as an optical/imaging ML model 141-1, an electrical ML model 141-2, an acoustic ML model 141-3, an electromagnetic ML model 141-4, a motion ML model 141-5, and other ML model 141-N), each configured to process pre-processed sensor data from a corresponding sensor type, and a synthesis ML model 350 configured to receive outputs from each of the plurality of sensor-specific ML models and produce, based at least in part on the outputs received from each of the plurality of sensor-specific ML models, the output representation. This adaptability allows the user-interface device 110 to handle diverse user communication styles and sensor configurations while maintaining a high degree of accuracy.

The output representation produced by the machine learning model(s) 141 can take various forms depending on the intended recipient and/or application. The output representation may include text transcription, audio reconstruction of the user's voice, translated language output, commands for device control, information for storage, etc. As discussed further with respect to FIG. 2, the output representation 222 may include linguistic outputs, security outputs, translation outputs, communication outputs, cognitive/emotional outputs, contextual outputs, assistant outputs, etc.

The universal translator 122 is configured to receive at least a portion of the output representation from the communication detector 121 and generate a translated output in a different language than a language of the inaudible communication. The universal translator 122 enables effortless real-time communication across language barriers, whether with AI agents or with other people, making the system ideal for travelers, diplomats, and other professionals.

As shown in FIG. 1, the system architecture supports flexible distribution of processing resources between the user-interface device 110, the user device 105, and remote computing resources 102. The user assistant system 180 may be distributed across multiple components. Specifically, FIG. 1 shows a user assistant system 180-1 that is part of or operating on the processor 114 of the user-interface device 110, a user assistant system 180-2 that is part of the computing device 102, and a user assistant system 180-3 operating on the user device 105. The user assistant system 180 may perform some or all of the functions and features discussed herein based on the collected sensor data. As illustrated, the user assistant system may be distributed among multiple devices (user interface device 110, user device 105, and/or computing device 102) or may solely reside and operate in the user interface device 110.

As such, the processing to perform sensor fusion and the detection of a user inner voice can be performed entirely by resources on the user-interface device 110 (e.g., the machine learning model(s) 141 residing on the processor 114 of the user-interface device 110 as part of user assistant system 180-1), by a combination of resources on the user-interface device 110 and resources remote from the user-interface device 110 (e.g., distributed between user assistant system 180-1, user assistant system 180-2, and/or the user assistant system 180-3), entirely by resources remote from the user-interface device 110 (e.g., on user assistant system 180-2 or user assistant system 180-3), etc. In some implementations, the pre-processing module(s) 131 is disposed within the housing 111 of the user-interface device 110, while the machine learning model(s) 141 is disposed on the computing device 102 and/or the user device 105 and communicatively coupled to the user-interface device 110 via the network interface 113. This distributed architecture enables the user-interface device 110 to leverage more powerful computational resources when available while maintaining the ability to perform basic processing locally.

The user assistant system 180 can be understood as comprising various ML models and software components that may be distributed across the user-interface device 110, the computing device 102, and/or the user device 105 in any combination. Various ones of the ML models (such as the machine learning model(s) 141 of the communication detector 121) or other software components (such as the identity authenticator 120, universal translator 122, or agent(s) 154) could be considered to be part of the user assistant system 180. This flexible architecture allows the system to optimize the distribution of computational workload based on available resources, power constraints, latency requirements, and other factors.

The computing device 102 and user device 105 shown in FIG. 1 can be or include any suitable hardware-based computing devices and/or multimedia devices, such as, for example, a server, a desktop compute device, a smartphone, a tablet, a wearable device, a laptop and/or the like. The computing device 102 and/or user device 105 includes a processor 153 and memory 155 connected to the processor 153.

The processor 153 of the computing device 102 and/or user device 105 can be, for example, a hardware-based integrated circuit (IC), or any other suitable processing device configured to run and/or execute a set of instructions or code stored in memory 155. For example, the processor 153 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a graphics processing unit (GPU), a programmable logic controller (PLC), a remote cluster of one or more processors associated with a cloud-based computing infrastructure and/or the like. The processor 153 is operatively coupled to the memory 155. In some implementations, the processor 153 can be coupled to the memory 155 through a system bus.

The memory 155 of the computing device 102 and/or user device 105 can be, for example, a random-access memory (RAM), a memory buffer, a hard drive, a read-only memory (ROM), an erasable programmable read-only memory (EPROM), and/or the like. The memory 155 can store, for example, one or more software modules and/or code that can include instructions to cause the processor 153 to perform one or more processes, functions, and/or the like. In some instances, the memory 155 can be remotely operatively coupled with the computing device 102, for example, via a network interface.

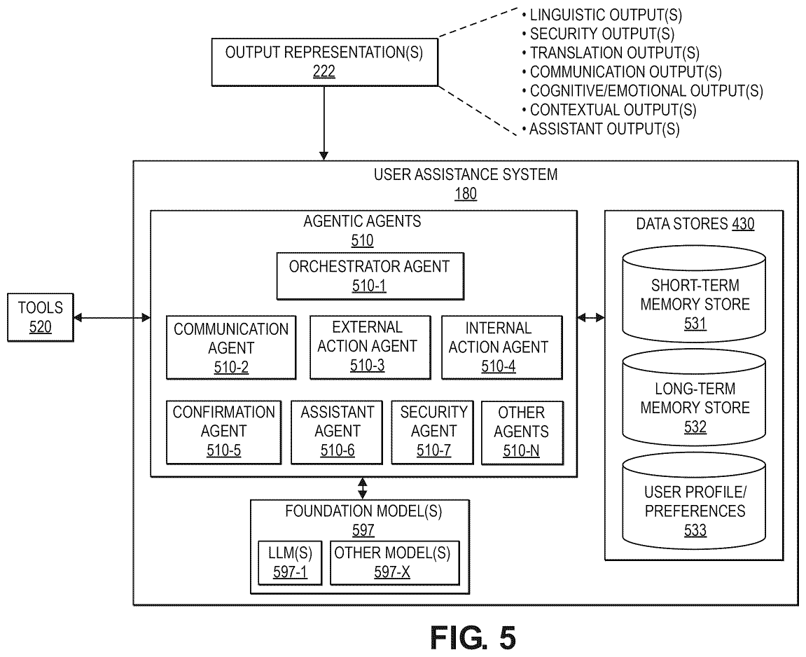

The processor 153 of the computing device 102 and/or user device 105 includes agent(s) 154 that can, for example, perform the functions described herein. For example, the agent(s) 154 is configured to receive the output representation of the content of the inaudible communication from the machine learning model(s) 141, determine, based at least in part on the output representation, an action to be performed, and cause the action to be performed. The agent(s) 154 can save and retrieve thoughts, create reminders, offer context-based suggestions, initiate actions on behalf of the user, etc. The agent(s) 154 enables the system to function as a personal AI assistant and communication device that can be used through inner voice in any environment. As discussed further with respect to FIG. 5, the agent(s) 154 may include agentic agents 510, which may include an orchestrator agent 510-1, a communication agent 510-2, an external action agent 510-3, an internal action agent 510-4, a confirmation agent 510-5, an assistant agent 510-6, a security agent 510-7, and other agents 510-N.

The network 199 connects the user-interface device 110 and the computing device 102 and/or user device 105, enabling bidirectional communication of sensor data, output representations, control signals, etc. The user interface system 100 operates by capturing multimodal sensor data from the user's physiological signals during inner voice communication via sensors 112 and detection and ranging system 117, processing this data through pre-processing module(s) 131 to clean and prepare it, analyzing the pre-processed data using ML model(s) 141 to interpret the content of the inaudible communication, and then routing the output representation 222 to appropriate recipients (such as the agent(s) 154 on the computing device 102 or to other users) for action or response. The system enables high-bandwidth, low-effort communication without audible vocalization, maintaining complete privacy and eliminating social awkwardness while preserving the natural language efficiency of spoken communication.

FIG. 2 is a block diagram illustrating the processing of one or more raw signals generated by the user interface system of FIG. 1, according to implementations of the present disclosure. FIG. 2 provides an overview of the signal processing pipeline within the communication detector 121, showing how multimodal raw signals 212 captured from the various sensors of the user-interface device 110 are processed through the pre-processing module(s) 131 and the ML model(s) 141 to produce the output representation 222 that captures the content of the user's inaudible communication.

The raw signals 212 represent the unprocessed sensor data streams collected from the multiple sensor modalities integrated into the user-interface device 110. These raw signals 212 include optical/imaging signals 212-1, electrical signals (ExG) 212-2, acoustic signals 212-3, electromagnetic signals 212-4, motion signals 212-5, and other signals 212-N. Each of these raw signal streams captures different physiological manifestations of the user's inaudible communication, whether that communication takes the form of mimed speech, whispered speech, or purely imagined speech. As discussed, any one or more of these sensors modalities may be included in the user interface device. Likewise, any one or more sensors of an included modality may be utilized.

The optical/imaging signals 212-1 are generated by one or more optical/imaging sensor(s) 112-1 and contain visual and optical data captured during the user's inaudible communication. These signals may include high-speed video data of micro-movements inside the ear, near-field infrared data reflecting changes in ear topology, interferometry data indicating micro-deformations based on light wave pattern changes, environmental image data from exterior-facing cameras, etc. The optical/imaging signals 212-1 provide rich spatial information about the physical movements and deformations occurring during speech-related muscle activity, such as inaudible speech.

The electrical signals (ExG) 212-2 are generated by one or more electrical (ExG) sensor(s) 112-2 and include electromyography (EMG) signals, electroencephalography (EEG) signals, etc. The EMG component of the electrical signals 212-2 captures the electrical activity associated with micro-movements of the jaw, tongue, vocal tract muscles, and potentially eye movements during the user's inaudible communication. These signals reflect the motor planning signals sent by the brain to the speech musculature, which occur even during imagined speech where no actual muscle movement takes place. The EEG component of the electrical signals 212-2 records neural signals from the brain, including efference copy and corollary discharge signals that are generated when the user thinks about speaking, thereby enabling detection of purely imagined speech patterns.

The acoustic signals 212-3 are generated by one or more acoustic sensor(s) 112-3 and capture sound-based information related to the user's inaudible communication. These signals may include data from microelectromechanical systems (MEMS) microphones that detect subtle acoustic signatures of jaw and tongue movements, SONAR data reflecting fine-grained motion in and around the ear, otoacoustic emissions data indicating changes in the ear during communication, ultrasound data providing detailed imaging of inner ear movements through high-frequency sound wave reflections, etc. The acoustic signals 212-3 are particularly effective at capturing the mechanical aspects of speech-related movements within and around the ear canal.

The electromagnetic signals 212-4 are generated by one or more electromagnetic sensor(s) 112-4 and provide information about both brain activity and physical deformations. These signals include functional near-infrared spectroscopy (fNIR) data capturing hemodynamic responses in the brain of the user (e.g., in the temporal lobe) during language processing, emotional responses, and memory formation, radio detection and ranging (RADAR) data detecting micro-deformations in or around the ear using electromagnetic waves, near-infrared (NIR) data that may capture additional biometric information, etc. The fNIR component of the electromagnetic signals 212-4 is particularly valuable as it provides insights into the cognitive and emotional state of the user during communication, enabling the system to capture not only linguistic content but also intent and affective context.

The motion signals 212-5 are generated by one or more motion sensor(s) 112-5, such as accelerometers and gyroscopes, and capture head movements and orientation of the user. The motion signals 212-5 may include data reflecting nodding gestures, head shaking, tilting, and/or other movements that can indicate confirmation, rejection, or directional intent during communication. These signals provide contextual information that can disambiguate user intent and enhance the interpretation of the other sensor modalities.

The other signals 212-N represent additional sensor data streams from any other sensors 112-N that may be included in the user-interface device 110. These may include temperature sensors, galvanic skin response sensors, pulse oximeters, or other physiological monitoring devices that can provide supplementary information relevant to interpreting the user's state and communication intent.

The pre-processing module(s) 131 receives the raw signals 212 from all sensor modalities and performs signal conditioning and preparation operations to transform the raw sensor data into a format suitable for processing by the ML model(s) 141. The pre-processing operations are useful for removing noise, artifacts, and irrelevant information from the raw signals while preserving the physiological features that encode the user's communication content. The pre-processing module(s) 131 may perform various operations depending on the specific sensor modality and signal characteristics, including noise reduction to remove environmental interference and sensor noise, motion artifact removal to eliminate signals caused by user movement unrelated to communication, filtering operations to isolate relevant frequency bands, normalization to standardize signal amplitudes across sensors, segmentation to identify communication events within continuous data streams, feature extraction to compute relevant parameters from the time-series data, etc.

In some implementations, the pre-processing module(s) 131 is disposed within the housing 111 of the user-interface device 110, enabling low-latency signal conditioning before transmission to remote computing resources. In other implementations, the raw signals 212 may be transmitted from the user-interface device 110 to the user device 105 or computing device 102, where the pre-processing module(s) 131 performs the signal conditioning operations. This flexibility in the location of pre-processing operations allows the system architecture to be optimized based on factors such as computational capabilities of the user-interface device 110, power consumption constraints, available bandwidth for data transmission, and latency requirements for real-time communication.

The ML model(s) 141 receives the pre-processed sensor data from the pre-processing module(s) 131 and performs sensor fusion and inference operations to produce the output representation 222 that captures the content of the user's inaudible communication. The ML model(s) 141 has been trained to recognize patterns across the multimodal sensor streams that correspond to specific linguistic units, such as phonemes, words, phrases, or complete utterances. The ML model(s) 141 performs the critical task of synthesizing information from the multiple sensor modalities to reconstruct the user's intended communication.

As illustrated in FIGS. 3A and 3B and discussed further below, the ML model(s) 141 may be configured in various architectural arrangements. In one configuration, the ML model(s) 141 comprises multiple separate sensor-specific ML models, each dedicated to processing pre-processed data from a corresponding sensor type, along with a synthesis ML model 350 that integrates the outputs from the sensor-specific models. In an alternative configuration, the ML model(s) 141 may be a single unified ML model that processes all sensor inputs collectively without separate per-sensor models.

The output representation 222 produced by the ML model(s) 141 encapsulates the interpreted content of the user's inaudible communication in a format suitable for downstream processing and application-specific uses. As shown in FIG. 2, the output representation 222 may include one or more types of outputs that capture different aspects of the communication. The linguistic output(s) within the output representation 222 comprise the core semantic content of the user's communication, which may be represented as text transcription, phonetic encoding, or reconstructed audio of the user's voice. The security output(s) include biometric authentication data derived from the unique patterns of muscle movement, brain activity, and ear topology exhibited by the user during communication, which can be used to verify user identity and detect spoofing attempts. The translation output(s) contain the user's communication content rendered in a different language than the original communication, enabling cross-language interaction. The communication output(s) represent the content in a format optimized for transmission to a communication partner, whether human or artificial agent. The cognitive/emotional output(s) capture the affective state, intent, and emotional context of the user during communication. The contextual output(s) include information about the environment, user state, and situational factors relevant to interpreting the communication. The assistant output(s) comprise information formatted for interaction with AI agents, virtual assistants, or other automated systems, potentially including commands, queries, or natural language requests.

FIGS. 3A and 3B are block diagrams illustrating additional details of the pre-processing module(s) 131 and machine learning model(s) 141 of FIGS. 1 and 2, according to implementations of the present disclosure.

FIG. 3A illustrates the data flow through the pre-processing module(s) 131 and the sensor-specific ML models. In the illustrated example, the raw signals 212 from the various sensors of the user-interface device 110 are received by corresponding sensor-specific pre-processors within the pre-processing module(s) 131. Specifically, the optical/imaging signals 212-1 are processed by the optical/imaging pre-processor 131-1, the electrical signals (ExG) 212-2 are processed by the electrical pre-processor 131-2, the acoustic signals 212-3 are processed by the acoustic pre-processor 131-3, the electromagnetic signals 212-4 are processed by the electromagnetic pre-processor 131-4, the motion signals 212-5 are processed by the motion pre-processor 131-5, and the other signals 212-N are processed by the other pre-processor 131-N.

Each sensor-specific pre-processor within the pre-processing module(s) 131 applies signal processing operations tailored to the characteristics of its corresponding sensor modality. The optical/imaging pre-processor 131-1 may perform operations such as image enhancement, motion compensation, feature extraction from visual data, and temporal alignment of video frames to identify relevant movements within the ear canal. The electrical pre-processor 131-2 may apply band-pass filtering to isolate EMG and EEG frequency bands of interest, artifact removal to eliminate non-neural electrical signals, independent component analysis to separate signal sources, and feature extraction to compute time-domain and frequency-domain features from the electrical signals. The acoustic pre-processor 131-3 may perform acoustic signal enhancement, echo cancellation, time-of-flight calculations for SONAR ranging, spectral analysis, and feature extraction from acoustic patterns. The electromagnetic pre-processor 131-4 may apply signal processing operations specific to fNIR and RADAR data, including hemodynamic response function modeling for fNIR signals, range-Doppler processing for RADAR signals, baseline correction, and feature extraction from electromagnetic sensor data. The motion pre-processor 131-5 may perform operations such as sensor fusion between accelerometer and gyroscope data, orientation estimation, gesture recognition, and extraction of motion features relevant to communication intent. The other pre-processor 131-N applies appropriate processing operations to any additional sensor modalities present in the system.

The outputs of the sensor-specific pre-processors are represented as pre-processed signals 312-1, 312-2, 312-3, 312-4, 312-5, and 312-N, which correspond to the pre-processed data from the optical/imaging sensor, electrical sensor, acoustic sensor, electromagnetic sensor, motion sensor, and other sensors, respectively. These pre-processed signals 312 contain the cleaned, conditioned, and feature-enhanced sensor data ready for input to the ML model(s) 141.

Each pre-processed signal stream is then fed to a corresponding sensor-specific ML model within the ML model(s) 141. The optical/imaging ML model 141-1 receives the pre-processed optical/imaging signals 312-1, the electrical ML model 141-2 receives the pre-processed electrical signals 312-2, the acoustic ML model 141-3 receives the pre-processed acoustic signals 312-3, the electromagnetic ML model 141-4 receives the pre-processed electromagnetic signals 312-4, the motion ML model 141-5 receives the pre-processed motion signals 312-5, and the other ML model 141-N receives the pre-processed other signals 312-N.

Each sensor-specific ML model is trained to extract high-level representations from its corresponding sensor modality that encode information relevant to the user's inaudible communication. These sensor-specific ML models may be implemented using various machine learning architectures, such as convolutional neural networks for processing spatial data from imaging sensors, recurrent neural networks or transformers for processing temporal sequences from electrical and acoustic sensors, or hybrid architectures that combine multiple neural network types. Each sensor-specific ML model produces an encoded output that captures the communication-relevant information present in its input sensor stream.

The outputs from each of the sensor-specific ML models 141-1, 141-2, 141-3, 141-4, 141-5, and 141-N are represented as intermediate outputs 314-1, 314-2, 314-3, 314-4, 314-5, and 314-N. These intermediate outputs 314 represent high-dimensional feature vectors or latent representations that encode the patterns detected by each sensor-specific ML model. The intermediate outputs 314 serve as inputs to the synthesis ML model(s) 350, which performs the sensor fusion operation.

The synthesis ML model(s) 350 receives the intermediate outputs 314-1, 314-2, 314-3, 314-4, 314-5, and 314-N from all of the sensor-specific ML models and integrates this multimodal information to produce the output representation 222. The synthesis ML model(s) 350 is trained to identify complementary and corroborating patterns across the different sensor modalities, enabling it to achieve higher accuracy and robustness than could be obtained from any single sensor modality alone. The synthesis ML model(s) 350 may be implemented using various neural network architectures capable of multimodal fusion, such as attention mechanisms that learn to weight the contributions of different sensor modalities based on their reliability in different contexts, transformer networks that can model complex interactions between modalities, or multi-layer perceptrons that combine the feature vectors from different modalities through learned nonlinear transformations. For example, the synthesis ML model(s) 350 may employ transformer-based architectures with cross-attention layers such as BERT-style or Vision Transformer architectures adapted for multimodal sensor fusion, graph neural networks that model inter-sensor relationships as graph structures where nodes represent individual sensor streams and edges capture cross-modal dependencies, or hierarchical fusion architectures that progressively integrate sensor modalities at multiple levels of abstraction. The sensor-specific ML models may similarly employ architectures optimized for their respective data types, such as convolutional neural networks (CNNs) like ResNet or EfficientNet for the optical/imaging ML model 141-1, recurrent neural networks such as LSTM or GRU networks for the electrical ML model 141-2 processing temporal EMG and EEG sequences, audio-specialized architectures like WaveNet or Wav2Vec for the acoustic ML model 141-3, and hybrid CNN-LSTM models for the electromagnetic ML model 141-4 that capture both spatial and temporal patterns in fNIR data.

The synthesis ML model(s) 350 performs sensor fusion by analyzing the patterns across the intermediate outputs 314 from the multiple sensor-specific ML models to reconstruct the content of the user's inaudible communication. This sensor fusion approach enables the system to leverage the strengths of each sensor modality while compensating for their individual limitations. For example, EMG signals may be particularly strong for detecting articulator movements during mimed or whispered speech, while EEG and fNIR signals may be more reliable for detecting purely imagined speech where minimal muscle activity occurs. The SONAR and RADAR signals may be most reliable for detecting micro-topological changes in the ear canal, while optical imaging may provide the highest spatial resolution for visible movements. By integrating information across these modalities, the synthesis ML model(s) 350 can achieve robust performance across different types of inaudible communication and in various environmental conditions.

FIG. 3B illustrates an alternative view of the system architecture that emphasizes the direct connection between the raw signals 212 and the pre-processing module(s) 131, and shows the subsequent flow to the synthesis ML model(s) 350. Similar to FIG. 3A, the raw signals 212-1, 212-2, 212-3, 212-4, 212-5, and 212-N are processed by the corresponding pre-processors 131-1, 131-2, 131-3, 131-4, 131-5, and 131-N to produce pre-processed signals 312-1, 312-2, 312-3, 312-4, 312-5, and 312-N. However, rather than utilizing individual ML models 141-1 through 141-N to process each pre-processed signal, in the example illustrated in FIG. 3B, all of the pre-processed signals 312-1 through 312-N are provided as inputs to the synthesis ML model(s) 350 to generate the output representation 222. In this illustration the synthesis ML model(s) 350 are trained to receive each of the pre-processed signals as inputs and produce the output representation 222, without the need for the pre-processed signals to first be processed by respective ML models 141-1 through 141-N.

Regardless of the configuration (FIG. 3A or 3B), the synthesis ML model(s) 350 produces the output representation 222, which, as described with respect to FIG. 2, may include one or more of linguistic output(s), security output(s), translation output(s), communication output(s), cognitive/emotional output(s), contextual output(s), or assistant output(s). The specific contents of the output representation 222 are determined by the patterns detected across the multimodal sensor inputs and the learned associations between those patterns and communication content established during training of the sensor-specific ML models and the synthesis ML model(s) 350.

The training of the sensor specific ML model(s) 141 and/or the synthesis ML model(s) 350 may be performed using various machine learning methodologies. In one approach, the system is trained end-to-end using a sequence-to-sequence framework where training data consists of synchronized multimodal sensor recordings paired with ground truth labels indicating the content of the user's communication. During training, the parameters of the sensor-specific ML models and the synthesis ML model(s) 350 are jointly optimized to minimize the difference between the predicted output representation 222 and the ground truth labels. Training data may be collected from diverse users producing known phrases or utterances in various styles of inaudible communication (mimed, whispered, and imagined speech) while the multimodal sensors record the corresponding physiological signals. This diverse training data enables the trained system to generalize across different users and communication styles.

In alternative training approaches, the sensor-specific ML models may be initially trained independently on sensor-specific tasks before being integrated with the synthesis ML model(s) 350. For example, the optical/imaging ML model 141-1 might be pre-trained on a task of predicting articulator positions from video data, the electrical ML model 141-2 might be pre-trained on EMG-based gesture recognition or EEG-based brain state classification, and the electromagnetic ML model 141-4 might be pre-trained on fNIR-based cognitive state prediction. After pre-training, these sensor-specific ML models can be fine-tuned in conjunction with the synthesis ML model(s) 350 on the end task of reconstructing communication content from multimodal sensor inputs.

In some implementations, the ML models may be initially trained on a large dataset and then fine-tuned for each specific user. For example, when a user starts using the user-interface device, the user may be taken through a training scenario during which the user audibly and/or using inner voice, generates one or more known outputs. Data collected during the training scenario may be labeled and used to tune the model(s) to the particularities of that user. Likewise, as the user utilizes the user-interface device, the user-interface device may periodically collect audible communications and/or inaudible communications that are confirmed by the user and utilize that information for ongoing periodic training of the ML model(s) for that user.

The output representation 222 produced by the synthesis ML model(s) 350 is used by downstream applications of the user interface system, including interaction with AI agents, communication with other users, device control, translation, and secure authentication. The rich multimodal sensing approach and advanced machine learning architecture illustrated in FIGS. 3A and 3B enable the user interface system to achieve high accuracy in interpreting the user's inaudible communication while maintaining robustness across diverse users, communication styles, and environmental conditions.

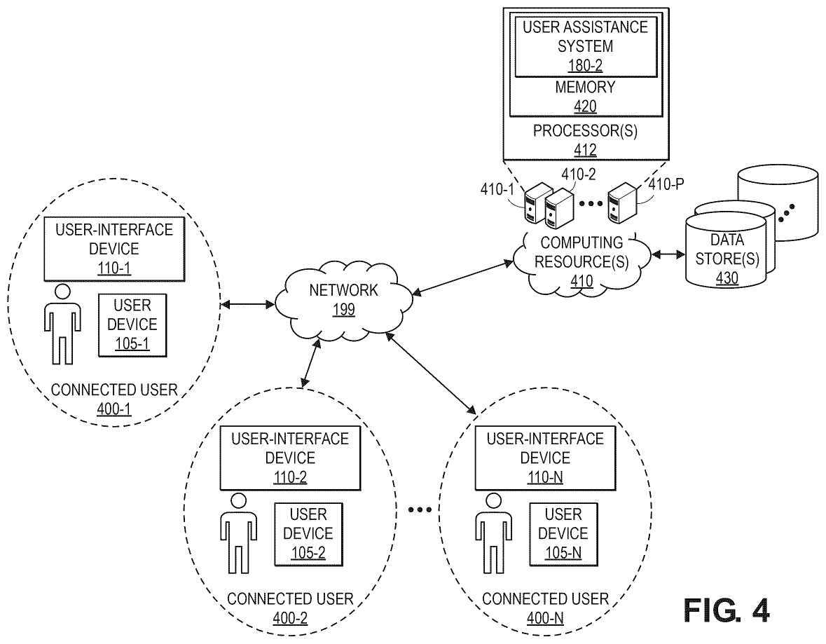

FIG. 4 illustrates an environment 101 in which a user assistance system 180-2 enables communication and collaboration between multiple connected users 400-1, 400-2, through 400-N. Each connected user includes a corresponding user-interface device and optionally a user device that facilitate both individual interaction with AI agents and inter-party communication between users. In the illustrated example, connected user 400-1 includes user-interface device 110-1 and user device 105-1, connected user 400-2 includes user-interface device 110-2 and user device 105-2, and connected user 400-N includes user-interface device 110-N and user device 105-N. There may be any number of connected users.

The user assistance system 180-2 includes computing resources 410 with one or more processors 412 and memory 420. These computing resources 410 provide the computational infrastructure necessary to coordinate communications, perform translations, manage shared information, and facilitate real-time interactions between multiple users. The system includes one or more data stores 430 that maintain conversation histories, translation models, user preferences, user profiles, and shared content accessible to multiple users during collaborative sessions.

The user assistance system 180-2 connects to each connected user 400-1, 400-2, through 400-N through a network 199, which can include wireless networks, cellular networks, local area networks, wide area networks, or combinations thereof. This network connectivity enables the system to receive sensor data and communications from each user-interface device 110-1 through 110-N, process that information using the computing resources 410, and distribute results to intended recipients among the connected users.

Each user-interface device 110-1 through 110-N includes some or all of the sensors and capabilities discussed herein. The pre-processing modules 131 and machine learning models 141 of each user-interface device generate output representations 222 that capture the content of each user's inaudible communications. In the illustrated example, these output representations 222 are transmitted through the network 199 to the user assistance system 180-2 for further processing and distribution. In other examples, the output representations may be sent directly to other user interface devices and/or other components, with or without the user assistance system 180-2 operating on the computing resources 410.

The user assistance system 180-2 processes communications from multiple users simultaneously, enabling real-time collaborative interactions. When a first connected user 400-1 generates an inaudible communication through their user-interface device 110-1, the system receives the corresponding output representation 222, determines the intended recipient(s) among the other connected users 400-2 through 400-N, and delivers the communication to those recipients through their respective user devices 105-2 through 105-N. This delivery can occur in multiple formats, including text displayed on the user devices, synthesized speech output through speakers of the user-interface devices or user devices, and/or haptic feedback through haptic output devices of the user-interface devices.

The user assistance system 180-2 and/or either the transmitting or receiving user interface device 110 enables universal translation between users who communicate in different languages. When connected user 400-1 generates a communication in a first language through user-interface device 110-1, the system detects the language of the output representation 222, determines the preferred language of the intended recipient(s), and performs real-time translation of the communication content. This translation occurs transparently, allowing users to communicate naturally in their native languages while receiving users are presented communications in their preferred languages. For example, when connected user 400-2 receives the translated communication through user device 105-2, the content is output in their preferred language while maintaining the semantic meaning and emotional context of the original communication from connected user 400-1. The translation capabilities extend to both text and speech outputs.

The disclosed implementations also facilitate shared information access among connected users 400-1, 400-2, through 400-N. When multiple users collaborate on a task or participate in a conversation, the data stores 430 maintain a shared context that includes conversation history, referenced documents, identified entities, and relevant background information. This shared context enables users to reference previous statements through their respective user-interface devices 110-1 through 110-N, ask follow-up questions that build on earlier discussions, and maintain coherent multi-party conversations even when individual users join or leave the session at different times.

The computing resources 410 include one or more computing instances 410-1, 410-2, through 410-P that can operate in parallel to handle communications from multiple connected users simultaneously. This distributed processing architecture enables the system to scale to support large numbers of concurrent users while maintaining low latency for real-time communication. Each processor 412 can handle multiple user sessions, coordinate translations, manage data store 430 access, and distribute communications to intended recipients.

The user assistance system 180-2 implements privacy and security controls that govern information sharing between connected users. The system maintains user profiles in data stores 430 that specify sharing permissions, communication preferences, and authorized recipient lists for each connected user 400-1 through 400-N. When processing a communication from user-interface device 110-1, the system verifies that connected user 400-1 has authorized the intended recipients to receive the communication, applies any content filtering or redaction rules specified in user preferences, and logs communication events for security auditing purposes.

The disclosed implementations also support multiple communication modes between connected users. In a direct messaging mode, a user's inaudible communication detected by their user-interface device is transmitted only to specifically identified recipients. For example, connected user 400-1 can send a private message through user-interface device 110-1 that is delivered only to connected user 400-2 through user device 105-2. In a broadcast mode, communications are distributed to all connected users 400-1 through 400-N in a shared session. In a selective sharing mode, users can designate different content to be shared with different subsets of connected users, enabling private side conversations within larger collaborative sessions.

FIG. 5 is a block diagram illustrating further details of the user assistance system 180, according to implementations of the present disclosure. As discussed above, components of the user assistance system 180 may all be included on the user-interface device 110, distributed between the user-interface device 110 and one or more of the user device 105 and/or the computing resources 102/410, and/or operating independent of the user interface component, e.g., on the user device 105 and/or the computing resources 102/410.

FIG. 5 illustrates a user assistance system 180 that processes output representations 222 generated by the communication detector 121 and orchestrates intelligent actions through a coordinated network of agentic agents 510. The agentic agents 510 include an orchestrator agent 510-1 that serves as the central coordinator for processing output representations 222 and determining appropriate actions. The orchestrator agent 510-1 receives the output representation 222 from the synthesis ML model(s) 350, as described with respect to FIGS. 3A and 3B, and analyzes the content to determine the user's intent, required actions, and which specialized agent(s) should be engaged to fulfill the request. The orchestrator agent 510-1 has access to foundation models 597 to leverage large language models (LLMs) 597-1 and/or other models 597-X for complex reasoning tasks, natural language understanding, and decision-making processes. The orchestrator agent 510-1 may send some or all of the output representation 222 to one or more of the other agentic agents 510 based on the determined intent and required actions.

The communication agent 510-2 handles communication-related actions determined by the orchestrator agent 510-1. When the output representation 222 indicates that the user intends to communicate with another person or system, the communication agent 510-2 processes this intent and coordinates the delivery of the communication. The communication agent 510-2 may access data stores, such as the user profile/preference data store 533, long-term memory data store 532, and/or short-term memory data store 531, to retrieve user preferences, contact information, communication histories, and contextual data necessary for formatting and delivering communications appropriately. The communication agent 510-2 can generate communications in multiple formats, including text messages, emails, voice communications, or inter-party communications as described with respect to FIG. 4, and may invoke the universal translator 122 when cross-language communication is required.

The external action agent 510-3 executes actions that interact with external systems, services, or devices outside the user interface system 100. When the orchestrator agent 510-1 determines that the output representation 222 requires interaction with external resources, it engages the external action agent 510-3 to perform these operations. The external action agent 510-3 has access to tools 520 that provide external capabilities such as application programming interfaces (APIs), database access systems, libraries, and other computational resources that enable interaction with third-party systems. For example, the external action agent 510-3 may interact with smart home devices, online services, enterprise applications, or other external platforms on behalf of the user based on the content of the inaudible communication captured by the user-interface device 110.

The internal action agent 510-4 manages actions that operate within the user interface system 100 or user device 105, such as adjusting system settings, managing local data, controlling device functions, storing memories or emotions in the short-term data store 531 and/or long-term data store 532, accessing information stored in one or more of the data stores 531/532/533, etc. The internal action agent 510-4 works in coordination with the orchestrator agent 510-1 to execute operations that do not require external system interaction.

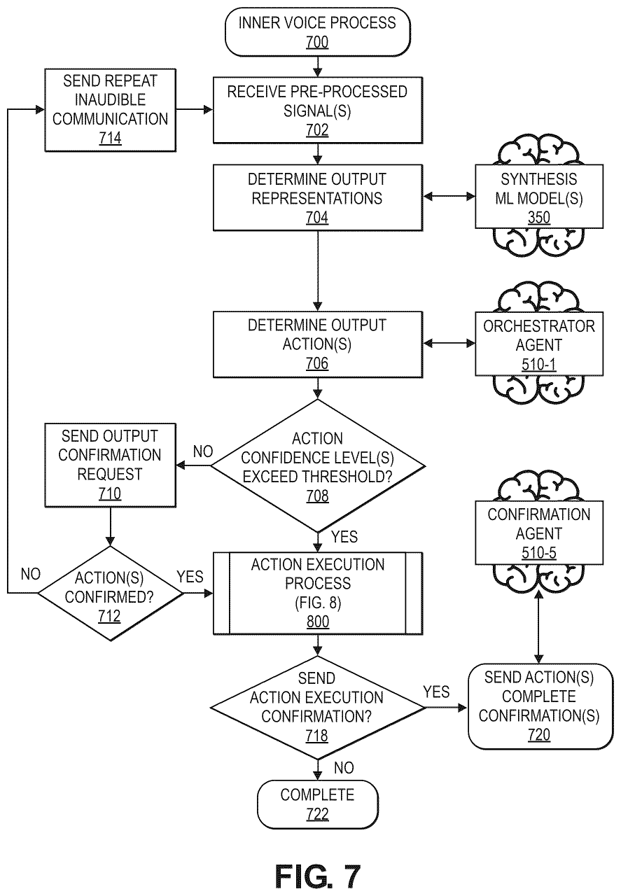

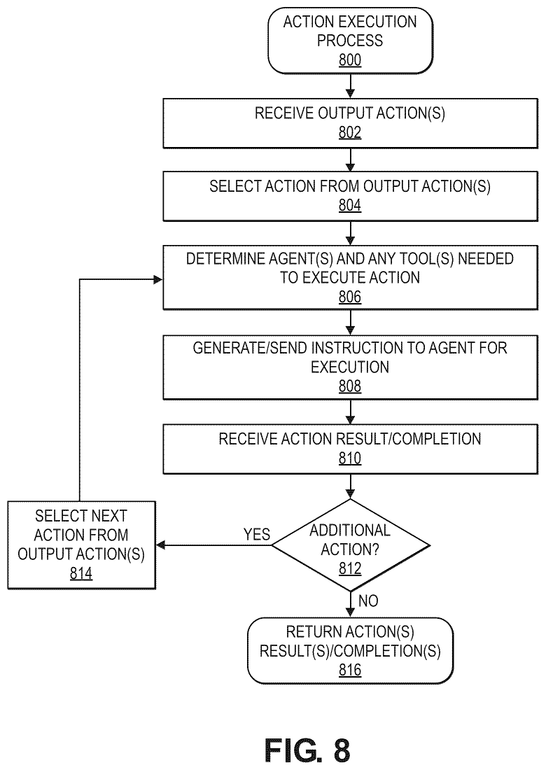

The confirmation agent 510-5 verifies and confirms actions before execution, particularly for operations that have significant consequences or that the system determines require explicit user approval. As illustrated in FIG. 7, when an action confidence level does not exceed a predetermined threshold, the orchestrator agent 510-1 engages the confirmation agent 510-5 to send an output confirmation request 710 to the user. The confirmation agent 510-5 generates confirmation prompts that may be presented to the user through output devices of the user-interface device 110 and/or user device 105, such as through audible feedback via speakers, haptic feedback via haptic devices, or visual feedback via display interfaces. The confirmation agent 510-5 receives the user's confirmation or denial response and coordinates with the orchestrator agent 510-1 to either proceed with action execution through the action execution process 800 (FIG. 8) or to request additional information or clarification from the user.

The assistant agent 510-6 provides intelligent assistance for complex tasks that require multi-step reasoning, contextual understanding, or ongoing interaction with the user. The assistant agent 510-6 leverages foundation models 597 to understand nuanced user requests, maintain conversation context across multiple interactions, and provide helpful responses or suggestions. The assistant agent 510-6 may access data stores 430 to retrieve conversation histories, user preferences, and contextual information that informs its responses. The assistant agent 510-6 works with the orchestrator agent 510-1 to handle queries that require explanation, guidance, or interactive problem-solving, transforming the output representation 222 into meaningful assistance that addresses the user's needs.

The security agent 510-7 implements security and privacy controls for the user interface system 100, monitoring and managing access to sensitive information, verifying user identity, and enforcing security policies. The security agent 510-7 works in coordination with the identity authenticator 120 described in FIG. 1 to ensure that actions are authorized and that user data is protected. The security agent 510-7 accesses data stores 430 to retrieve security policies, access control lists, authentication credentials, and privacy settings. When the orchestrator agent 510-1 determines that an action involves sensitive operations or data access, it engages the security agent 510-7 to verify authorization and apply appropriate security measures before allowing the action to proceed.

Additional agents 510-N may be included in the agentic agents 510 to provide specialized functionality for specific domains or use cases. These additional agents operate under the coordination of the orchestrator agent 510-1 and may include domain-specific agents for tasks such as scheduling, financial transactions, health monitoring, or other specialized operations. Each additional agent 510-N has access to the foundation models 597, data stores 430 (e.g., 531, 532, 533), and tools 520 as needed to perform its designated functions.

The foundation models 597 provide computational intelligence for the agentic agents 510, including large language models (LLMs) 597-1 and other models 597-X. These foundation models 597 typically include large language models with hundreds of billions of parameters that enable advanced natural language understanding, reasoning, and generation capabilities. The agents 510 leverage the foundation models 597 to interpret complex user intents, generate appropriate responses, make intelligent decisions, and perform tasks that require broad knowledge and reasoning abilities. Multiple agents may access the foundation models 597 concurrently, with the orchestrator agent 510-1 managing resource allocation and coordination to ensure efficient system operation.

The data stores 430, such as short-term memory data store 531, long-term memory data store 532, user profile/preferences data store 532, maintain domain-specific information, user data, system configurations, policies, and contextual knowledge accessible to the agentic agents 510. These data stores may include structured databases, document repositories, user profiles, conversation histories, operational data, etc., that inform agent behavior and decision-making, etc. The agents 510 query the data stores as needed to retrieve relevant information for processing output representations 222 and executing actions. The data stores may be continuously or periodically updated based on user interactions, system operations, and external data sources, enabling the agents 510 to operate with current and accurate information.

The tools 520 provide external capabilities to the agentic agents 510, extending their functionality beyond the core system components. These tools 520 include application programming interfaces (APIs) for interacting with external services, code interpreters for executing computational tasks, specialized algorithms for data processing, communication protocols for network operations, and other computational resources. The agents 510 access tools 520 through standardized interfaces managed by the orchestrator agent 510-1, enabling consistent integration and coordinated tool usage across the agent network. When processing an output representation 222, the orchestrator agent 510-1 may determine that specific tools 520 are needed and direct the appropriate specialized agent (such as external action agent 510-3) to utilize those tools to accomplish the requested task.

During operation, the orchestrator agent 510-1 receives an output representation 222 containing linguistic outputs, security outputs, translation outputs, communication outputs, cognitive/emotional outputs, contextual outputs, and/or assistant outputs, as described with respect to FIG. 2. The orchestrator agent 510-1 analyzes the output representation to understand the user's complete intent, emotional state, context, and desired outcomes. Based on this analysis and leveraging the foundation models 597 for reasoning, the orchestrator agent 510-1 determines which agent(s) 510 should receive some or all of the output representation 222 and what actions should be executed. The orchestrator agent 510-1 may engage multiple agents 510 concurrently or sequentially, coordinating their activities to fulfill complex user requests that require multiple types of operations.

For example, if the output representation 222 indicates that the user wants to send a message to a colleague about a meeting, the orchestrator agent 510-1 may engage the assistant agent 510-6 to understand the full context and determine the appropriate message content, the communication agent 510-2 to format and deliver the message through the appropriate channel, and potentially the security agent 510-7 to verify the authenticity of the user. If the message requires translation, the orchestrator agent 510-1 coordinates with the communication agent 510-2 to invoke the universal translator 122.

The agentic agents 510 may also utilize additional tools 520 beyond those explicitly shown in FIG. 5. These additional tools may include specialized APIs for domain-specific operations, machine learning models for particular tasks, external databases, third-party services, or custom computational resources. The orchestrator agent 510-1 maintains awareness of available tools 520 and their capabilities, selecting appropriate tools based on the requirements of each task and directing the relevant specialized agents to utilize those tools as needed.

FIG. 6 illustrates an example user identity verification process 600 that the identity authenticator 120/security agent 510-7 performs to ensure that only authorized users can access the capabilities of the user-interface device 110, according to implementations of the present disclosure. This verification process provides security by analyzing the unique physiological patterns captured by the sensors 112 during inaudible communications of the user and comparing these patterns against stored biometric profiles for that user. The process enables continuous authentication throughout user interactions, preventing unauthorized access even if the physical device is obtained by another individual.

The user identity verification process 600 begins by receiving one or more pre-processed signals, as in 602. As discussed above, pre-processed signal(s) are generated by the pre-processing module(s) 131 from the raw signals 212 captured by the various sensors 112 of the user-interface device 110, as discussed with respect to FIGS. 2, 3A, and 3B. The pre-processed signal(s) contain cleaned and conditioned sensor data that reflects the physiological characteristics exhibited by the individual currently using the user-interface device 110. These signals may include patterns from EMG sensors reflecting muscle movement characteristics, EEG signals indicating neural activity patterns, detection-and-ranging data capturing ear topology, motion patterns from accelerometers and gyroscopes, and/or other sensor modalities that collectively create a unique biometric signature for each individual.

The identity authenticator 120/security agent 510-7 compares the pre-processed signal(s) with stored user identity signals to generate a user identity score, as in 604. The stored user identity signals represent a biometric profile of the authorized user that was previously established during an enrollment or training phase when the authorized user configured the user-interface device 110. During this comparison operation, the identity authenticator 120/security agent 510-7 analyzes multiple dimensions of similarity between the current pre-processed signal(s) and the stored biometric profile. For example, the comparison may evaluate the similarity of muscle activation patterns in EMG data, the correspondence of neural response patterns in EEG and fNIR data, the match between ear topology deformations detected during speech, the consistency of head movement patterns during communication, and/or other physiological characteristics that exhibit individual variability. The comparison operation produces a user identity score that quantifies the degree of match between the current physiological signals and the stored biometric profile, with higher scores indicating greater confidence that the current user is the authorized user.

The identity authenticator 120/security agent 510-7 determines whether the user identity score exceeds a user identity threshold, as in 606. This threshold represents a predetermined confidence level that balances security requirements against usability considerations. If the threshold is set too low, unauthorized individuals may gain access to the system, while if the threshold is set too high, the authorized user may experience frequent false rejections that require additional verification steps. The threshold may be configured based on the sensitivity of the operations that the user-interface device 110 can perform, the security policies of organizations deploying the system, or user preferences regarding the trade-off between security and convenience. In some implementations, the threshold may be adjusted dynamically based on contextual factors such as the type of action being requested, the current environment, the time since the last successful authentication, or risk assessments performed by the security agent 510-7.

If the user identity score exceeds the user identity threshold, the identity authenticator 120/security agent 510-7 allows the inner voice process, discussed herein and below with respect to FIG. 7, to proceed, as in 616. This allows the authenticated user to interact with the user assistance system 180 using their inaudible communications, with full access to the features and capabilities of the system. If the user identity score does not exceed the user identity threshold, the identity authenticator 120/security agent 510-7 blocks the inner voice process (FIG. 7) from proceeding, as in 608. By blocking the inner voice process 700, unauthorized individual access to the user-interface device 110 is prohibited. This blocking operation provides security even in scenarios where an unauthorized individual has physical possession of the user-interface device 110, as the biometric authentication prevents functional use of the device without matching the authorized user's unique physiological patterns.

After blocking the inner voice process, the identity authenticator 120/security agent 510-7 determines whether to obtain secondary user identity verification, as in 610. This determination may be based on factors such as how close the user identity score was to the threshold, whether this is the first failed authentication attempt or a repeated failure, security policies that govern authentication procedures, or contextual information about the current situation. If the identity authenticator 120/security agent 510-7 determines that secondary verification should not be obtained, the process maintains the block on inner voice process and returns to block 602.

If the identity authenticator 120/security agent 510-7 determines that secondary verification should be obtained, it requests and receives secondary user identity verification, as in 612. Secondary user identity verification provides an additional authentication factor beyond the biometric signals automatically captured by the sensors 112 during inaudible communication attempts. This secondary verification may take various forms depending on the implementation and security requirements. For example, the identity authenticator 120/security agent 510-7 may request that the user provide a passphrase, PIN code, or password through audible speech or through interaction with the user device 105. As another example, the identity authenticator 120/security agent 510-7 may request that the user perform a specific gesture or head movement pattern that can be detected by the motion sensors 112-5 to confirm their identity. In some implementations, the identity authenticator 120/security agent 510-7 may request that the user authenticate using a separate device, such as by approving the authentication request on a smartphone, smartwatch, or other trusted device associated with the user's account. The identity authenticator 120/security agent 510-7 may also employ multi-factor authentication by requesting multiple forms of secondary verification, such as both a passphrase and a gesture confirmation.

The identity authenticator 120/security agent 510-7 then determines whether the user identity is confirmed based on the secondary verification, as in 614. This determination evaluates whether the secondary verification information provided by the individual matches the expected credentials or patterns associated with the authorized user. For passphrase verification, the system may compare the provided passphrase against a stored passphrase for the authorized user. For gesture-based verification, the system may analyze the motion patterns detected by the sensors 112-5 to determine whether they match the expected gesture sequence. For device-based verification, the system may confirm whether the authentication request was approved on a trusted device within an acceptable time window.

If the user identity is not confirmed through the secondary verification, the process 600 returns to block 608 and maintains the block on inner voice process, thereby maintaining security by preventing unauthorized use. If the user identity is confirmed through the secondary verification, the identity authenticator 120/security agent 510-7 allows the inner voice process 700 (FIG. 7) to proceed, as in 616, granting the user access to the full capabilities of the user assistance system 180.

The user identity verification process 600 illustrated in FIG. 6 provides continuous security monitoring throughout user interactions with the system. Because the pre-processed signals are generated continuously as the user produces inaudible communications, the identity authenticator 120/security agent 510-7 can repeatedly perform the verification process 600 to ensure that the authorized user remains the individual using the device. This continuous authentication capability detects scenarios where an unauthorized individual attempts to use the device after it has been unlocked, or where the device is transferred between individuals during a communication session.

FIG. 7 illustrates an example inner voice process 700, according to implementations of the present disclosure. The example process 700 represents an example operational flow that occurs during typical usage of the disclosed implementations, where the user generates inaudible communications that are detected by the sensors 112, processed by the pre-processing module(s) 131 and ML model(s) 141, and then acted upon by one or more agents 510 to fulfill the intent of the user. The inner voice process 700 may coordinate multiple system components including the communication detector 121, the orchestrator agent 510-1, the confirmation agent 510-5, and the synthesis ML model(s) 350 to provide a responsive and intelligent user experience.

The inner voice process 700 begins by receiving pre-processed signals, as in 702. These pre-processed signals are generated by the pre-processing module(s) 131 from the sensor data captured by the sensors 112 as the user produces an inaudible communication, as described herein. The pre-processed signal(s) contain the cleaned and conditioned sensor data that encodes the physiological manifestations of the user's intended communication. The pre-processed signals may include any one or more of muscle movements detected by EMG sensors, neural activity patterns captured by EEG and fNIR sensors, micro-deformations in the ear detected by the detection-and-ranging system, and/or other modalities that provide the information needed to reconstruct the content of the user's inaudible communication.

The system determines output representations from the pre-processed signals, as in 704. This determination operation is performed by the synthesis ML model(s) 350, which receives either the pre-processed signal(s) directly or the intermediate output(s) 314 from the sensor-specific ML models 141, as discussed above with respect to FIGS. 3A and 3B. The synthesis ML model(s) 350 performs sensor fusion to integrate information across the multiple sensor modalities and produces an output representation 222 that captures the linguistic content of the inaudible communication, along with additional information such as emotional state, context, security indicators, and/or other aspects discussed. The output representation 222 may include text transcription of the inaudibly spoken words, audio reconstruction of the user's voice with appropriate prosody and emotional inflection, semantic representations that capture the meaning and intent of the communication, and/or contextual information about the user's state and environment that informs interpretation of the communication.

The orchestrator agent 510-1 determines output actions based on the output representations, as in 706. This determination analyzes the content of the output representation 222 to understand what the user intends to accomplish through their inaudible communication. The orchestrator agent 510-1 may leverage the foundation models 597 to perform natural language understanding, intent recognition, and reasoning about appropriate responses to the user's communication. For example, if the output representation 222 indicates that the user said “remind me to call John at 3 pm,” the orchestrator agent 510-1 determines that the appropriate output action is to create a reminder with the specified parameters. If the output representation 222 indicates that the user said “send a message to Sarah saying I'll be late,” the orchestrator agent 510-1 determines that the appropriate output actions include identifying the recipient Sarah from the user's contacts, composing a message with the specified content, and transmitting the message through an appropriate communication channel. The orchestrator agent 510-1 may determine multiple output actions for a single output representation, such as when a complex request requires several steps to fulfill, or when the communication triggers both internal system operations and external actions.

The system determines whether action confidence levels exceed a threshold, as in 708. This determination evaluates how confident the system is that the determined output actions correctly correspond to the user's intent as expressed in their inaudible communication. The confidence levels may be generated by the ML model(s) 141 during the interpretation of the pre-processed signals, by the orchestrator agent 510-1 during the action determination process, or by both components with the final confidence representing a combination of interpretation confidence and action selection confidence. The threshold against which the confidence levels are compared may be any defined value that balances the trade-off between system responsiveness and accuracy. The threshold may vary based on factors such as the individual user's preference for confirmation requests, the type of action being considered (with higher thresholds for actions that have significant consequences), the current context or environment, historical accuracy rates for similar communications from this user, the potential impact if an incorrect action is executed, etc. For example, a simple information query might use a lower confidence threshold since an incorrect response has minimal negative impact, while an action that will transfer funds or delete data might require a higher confidence threshold to ensure the user intended that specific operation.

If the action confidence levels exceed the threshold, the system proceeds directly to the action execution process 800, which is illustrated in detail in FIG. 8 and described below. If the action confidence levels do not exceed the threshold, the confirmation agent 510-5 sends an output confirmation request to the user, as in 710. This confirmation request presents information about the determined output actions to the user and requests explicit approval before proceeding with execution. The confirmation request may be delivered to the user through various output modalities depending on the context and user preferences. For example, the confirmation request may be presented as synthesized speech output through the speaker 116-1 of the user-interface device 110, stating something like “I understood you want to send a message to Sarah saying you'll be late. Should I proceed?” Alternatively, or additionally, the confirmation request may be presented as text displayed on the user device 105, as a specific haptic pattern through the haptic device 116-2 that the user has learned to associate with confirmation requests, or through other output mechanisms.

After sending the output confirmation request, the system determines whether the actions are confirmed by the user, as in 712. This determination analyzes the user's response to the confirmation request to ascertain whether the user approves the proposed actions. The user may provide confirmation through various input modalities. For example, the user may generate an inaudible communication such as “yes” or “proceed” that is detected and interpreted through the same sensor and processing pipeline used for the original communication. The user may perform a gesture such as nodding their head, which is detected by the motion sensors 112-5 and interpreted as confirmation. The user may interact with the user device 105 to tap an approval button on a displayed interface. In some implementations, the system may wait for a predetermined timeout period after sending the confirmation request, and if no negative response is received within that period, the system may interpret the lack of response as implicit confirmation and proceed with the actions.

If the actions are not confirmed, the confirmation agent 510-5 sends a request to the user to repeat the inaudible communication, as in 714, and the process returns to block 702 and continues. If it is determined that a confirmation has been received, the action execution process 800 (FIG. 8) is performed. After or as the actions are executed as part of the example process 800, discussed below, a determination is made as to whether an action execution confirmation is to be provided to the user, as in 718. If it is determined that an action execution confirmation is not to be provided, the example process 700 completes, as in 722. If it is determined that a confirmation is to be provided to the user, the confirmation agent generates and sends an action completion confirmation(s) to the user once the action(s) is completed, as in 720. These completion confirmations inform the user that the requested actions have been successfully executed, providing feedback that allows the user to verify that their communication was interpreted correctly and that the desired operations were performed. The completion confirmations may be delivered through various output modalities, such as synthesized speech stating “I've sent your message to Sarah,” a brief haptic pulse through the haptic device 116-2 indicating successful completion, a notification displayed on the user device 105, and/or other feedback mechanisms.

FIG. 8 illustrates an example action execution process 800 that the user assistance system 180 performs to execute the output actions determined through the inner voice process 700, according to implementations of the present disclosure. This process coordinates the various agentic agents 510 and tools 520 to fulfill the user's intent as captured in the output representation 222.

The action execution process 800 begins by receiving one or more output actions, as in 802. These output action(s) are determined by the orchestrator agent 510-1 during the inner voice process 700, as described with respect to FIG. 7. The output action(s) represent the operations that the system should perform to fulfill the user's intent as expressed in their inaudible communication. The output action(s) may include simple single-step operations or complex multi-step workflows that require coordination across multiple agents and tools. Each output action includes parameters that specify the details of the operation to be performed, such as recipients for communications, content to be transmitted, external systems to be accessed, data to be stored or retrieved, other information needed to execute the action, etc.

The orchestrator agent 510-1 selects an action from the output action(s) for processing, as in 804. When multiple output actions are associated with a single user communication, this selection determines the order in which the actions will be executed. The selection may prioritize actions based on factors such as dependencies between actions (executing prerequisite actions before dependent actions), urgency or time-sensitivity of different operations, resource availability for different types of actions, optimization of overall execution efficiency, etc. For example, if the output actions include both retrieving information from a data store and transmitting a communication to another user, the system may select the information retrieval action first so that the retrieved data can be included in the communication. In other implementations, actions that are not dependent on one another may be executed in parallel.

For the selected action the orchestrator agent 510-1 determines which agent(s) and tool(s) are needed to execute the selected action, as in 806. This determination analyzes the type of operation represented by the selected action and identifies the specialized agent(s) 510 that have the capabilities to perform that operation, as well as the tool(s) 520 that may be required to interact with external systems or perform computational tasks. The orchestrator agent 510-1 maintains knowledge about the capabilities of each specialized agent and the available tools, enabling it to route actions to the appropriate components for execution. For example, if the selected action involves sending a message to another user, the orchestrator agent 510-1 determines that the communication agent 510-2 should handle this action, as the communication agent 510-2 specializes in inter-party communications as described with respect to FIG. 5. The orchestrator agent 510-1 also determines which tools 520 are needed, such as messaging APIs for SMS, email, or other communication platforms, or translation tools if the message needs to be translated to the recipient's preferred language. As another example, if the selected action involves controlling a smart home device, the orchestrator agent 510-1 determines that the external action agent 510-3 should handle this action, since it specializes in interacting with external systems, and that the appropriate smart home control API is needed from the tools 520. As yet another example, if the selected action involves storing a memory or note for later retrieval, the orchestrator agent 510-1 determines that the internal action agent 510-4 should handle this action, since it manages operations within the user assistance system 180, and that database or data store access tools are needed to persist the information.

The orchestrator agent 510-1 generates and sends an instruction to the appropriate agent for execution, as in 808. The instruction contains all the information needed by the specialized agent to execute the action, including the specific operation to perform, parameters that specify details of the operation, references to the tools 520 that should be utilized, authentication or permission information needed to access resources, and any context from the output representation 222 that may inform the agent's execution of the action. The specialized agent receives the instruction and executes the specified operation using its domain-specific capabilities and the identified tools 520. For example, when the communication agent 510-2 receives an instruction to send a message, it accesses the data stores 430 to retrieve the contact information for the specified recipient, formats the message content appropriately for the selected communication channel, invokes the relevant messaging API from the tools 520 to transmit the message, and may also invoke the universal translator 122 if the message needs to be translated to a different language. When the external action agent 510-3 receives an instruction to control a smart home device, it authenticates with the external system using credentials stored in the data stores, invokes the appropriate control API from the tools 520 with the specified parameters, and may verify that the requested state change was successfully applied to the device. When the internal action agent 510-4 receives an instruction to store information, it organizes the data appropriately, stores it in the data stores 430 and may generate metadata such as timestamps, tags, or associations that will enable later retrieval.

The orchestrator agent 510-1 receives the action result or completion from the executing agent, as in 810. After the specialized agent completes execution of the action, it returns information to the orchestrator agent 510-1 indicating the outcome of the operation. The action result may indicate successful completion of the requested operation, partial completion if some aspects of the action succeeded while others failed, or failure if the operation could not be performed. The result may also include data returned by the operation, such as information retrieved from a data store, responses received from external systems, or other output generated during action execution. This result information enables the orchestrator agent 510-1 to determine whether the user's intent has been fulfilled and whether any follow-up actions are needed.

The orchestrator agent 510-1 then determines whether there are additional actions to execute, as in 812. This determination evaluates whether the output actions received at block 802 included multiple actions, and whether any actions remain that have not yet been executed. If additional actions remain, the system selects the next action from the output actions, as in 814, and returns to block 806 to determine the agents and tools needed for that next action. This iterative process continues until all output actions have been executed, enabling the system to handle complex user communications that require multiple operations to fulfill completely.

When no additional actions remain to be executed, the orchestrator agent 510-1 returns the results and completions from all executed actions, as in 816. These results are returned to the inner voice process 700, which may then generate completion confirmations to inform the user that their requested actions have been executed, as described with respect to FIG. 7 at block 720.

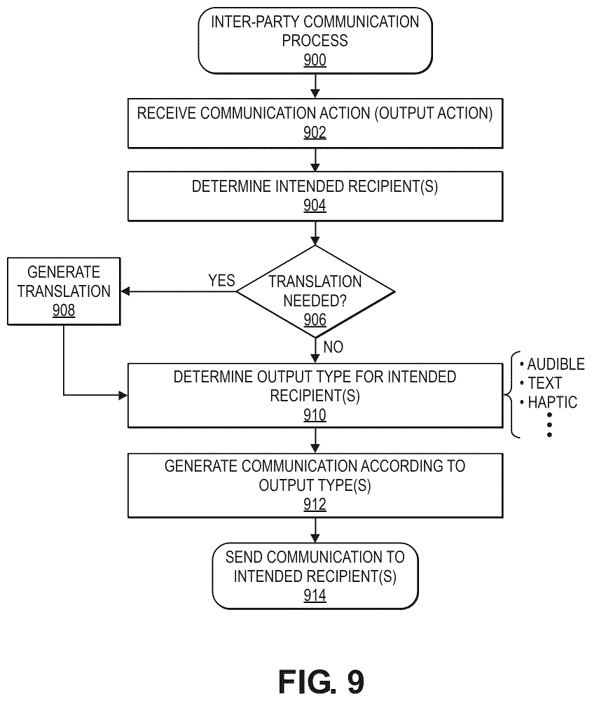

FIG. 9 illustrates an example inter-party communication process 900 that the communication agent 510-2 performs to facilitate communication between the user of the user-interface device 110 and one or more intended recipients, according to implementations of the present disclosure. This process enables users to communicate with other individuals through their inaudible communications, with the system handling the delivery, formatting, and translation of messages to ensure that recipients receive communications in appropriate and accessible formats. The inter-party communication process 900 supports the telepathic-like communication experience where users can silently convey messages to others while the system manages the technical details of message delivery.

The inter-party communication process 900 begins by receiving a communication action, as in 902. This communication action is an output action determined by the orchestrator agent 510-1 during the inner voice process 700 and selected for execution during the action execution process 800, as described with respect to FIGS. 7 and 8. The communication action indicates that the user intends to send a message or other communication to one or more recipients, and includes information about the content to be communicated, which is derived from the output representation 222 of the user's inaudible communication.

The communication agent 510-2 determines the intended recipients of the communication, as in 904. This determination analyzes the output representation 222 and the parameters of the communication action to identify to whom the user wishes to communicate. The intended recipients may be explicitly specified in the user's inaudible communication, such as when the user says “send a message to John” or “tell Sarah that I'm running late.” In these cases, the communication agent 510-2 resolves the recipient names to specific individuals by querying the data stores 430 to access the user's contact list or address book, identifying matching entries based on the name, and handling ambiguities if multiple contacts match the specified name by either selecting the most likely recipient based on context and communication history or requesting clarification from the user.

In some implementations, the intended recipients may be determined implicitly based on context rather than explicit specification. For example, if the user generates an inaudible communication during an active conversation session with specific other users, the communication agent 510-2 may determine that those conversation participants are the intended recipients. If the user's communication references a previous message or conversation thread, the communication agent 510-2 may determine that the participants in that previous communication are the intended recipients. The communication agent 510-2 may also leverage the assistant agent 510-6 and/or foundation models 597 to perform reasoning about likely intended recipients based on the content of the communication and/or contextual factors.

The communication agent 510-2 determines whether translation is needed for the communication, as in 906. This determination compares the language of the user's original inaudible communication with the preferred languages of the identified recipients. The communication agent 510-2 may access the data stores 430 to retrieve language preference information for each recipient, which may be explicitly configured in recipient profiles or inferred from previous communications with those recipients. If any recipient's preferred language differs from the language of the user's communication, translation may be needed to enable that recipient to understand the message in their native or preferred language. In other examples, translation may be omitted on the sending side and a receiving user interface device may perform translation of the communication.

If translation is needed, the communication agent 510-2 generates the translation, as in 908, by invoking the universal translator 122 described with respect to FIG. 1. The universal translator 122 receives the content of the user's communication from the output representation 222 and the target language for translation, and produces a translated version of the communication content in the target language. The translation preserves the semantic meaning of the original communication while rendering it in the recipient's language. When multiple recipients require translations to different languages, the communication agent 510-2 generates separate translations for each target language, enabling each recipient to receive the communication in their preferred language. This multilingual distribution capability enables seamless communication across language barriers, supporting scenarios such as international business communications where participants speak different languages, personal communications between users in different countries, or multilingual group conversations where participants prefer different languages.

After generating the translation(s) or if it is determined that translation is not needed, the communication agent 510-2 determines the output type for each intended recipient, as in 910. This determination identifies how the communication should be formatted and delivered to each recipient to ensure they receive the message in an accessible and appropriate manner. The output type may be determined based on factors such as the capabilities of the recipient's device or interface, the recipient's preferences for receiving communications, the current context or availability status of the recipient, the nature and urgency of the communication content, and the communication channel or platform being used. The output type determination may select from various format options for presenting the communication to each recipient. For example, the output type may be audible speech synthesized from the communication content and played through the recipient's user-interface device 110 or other audio output device, enabling the recipient to hear the message as if it were spoken aloud by the user. As another example, the output type may be text displayed on a screen of the recipient's user device 105, enabling the recipient to read the message silently. As yet another example, the output type may be haptic feedback patterns delivered through a haptic device 116-2 on the recipient's user-interface device 110, which might be appropriate for brief, pre-configured message types or alerts. In some implementations, multiple output types may be used simultaneously, such as displaying text while also providing an audio notification that a message has been received.

The communication agent 510-2 generates the communication according to the determined output types, as in 912. This generation process formats the communication content (potentially including the translated version if translation was needed) into the appropriate format for each output type and recipient. For audible output, this involves synthesizing speech from the text of the communication, potentially using voice synthesis models that can recreate natural-sounding speech with appropriate prosody and emotional inflection. For text output, this involves formatting the communication content for display, potentially including metadata such as sender identification, timestamp, and any attachments or additional context. For haptic output, this involves encoding the communication into haptic patterns that convey the message meaning to the recipient.

The communication agent 510-2 sends the communication to the intended recipients, as in 914. This transmission operation may utilize one or more tools 520 to deliver the formatted communication to each recipient through appropriate communication channels or platforms. The communication agent 510-2 may leverage various communication mechanisms depending on the recipients' connectivity and the nature of the communication. For recipients who are also users of the user assistance system 180 with their own user-interface devices 110, the communication may be transmitted through the network 199 directly to the recipients' user assistance system instances, as illustrated in FIG. 4. For recipients who are not users of the system but who are reachable through conventional communication channels, the communication agent 510-2 may invoke external messaging APIs from the tools 520 to send the communication via SMS, email, instant messaging platforms, or other third-party communication services.

After sending the communication to all intended recipients, the inter-party communication process 900 completes, returning control to the action execution process 800, which may continue with additional actions if the communication action was one of multiple actions to be executed. The communication agent 510-2 may log information about the completed communication in the data stores 430, maintaining a history of inter-party communications that can be referenced in future interactions.

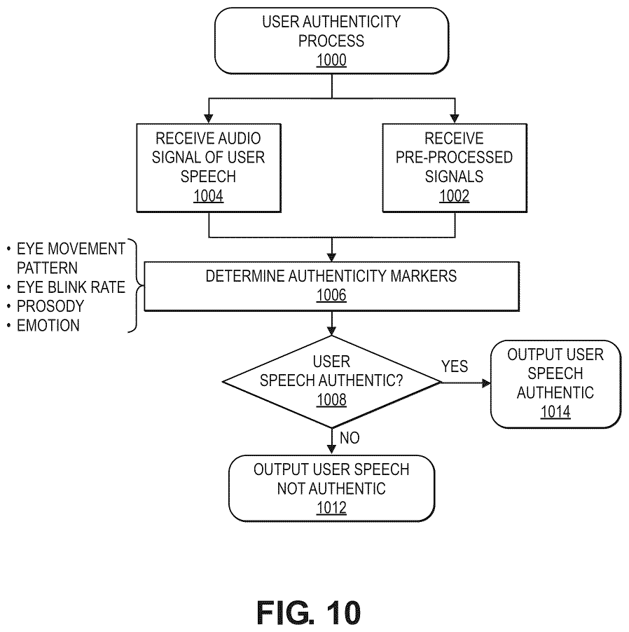

FIG. 10 illustrates an example user authenticity process 1000, according to implementations of the present disclosure. The example process 1000 may be performed by the user assistance system 180 to determine whether detected speech represents authentic communication from the user or whether the user is merely reading scripted content. This capability addresses an emerging challenge in human-computer interaction and secure communications: as artificial intelligence systems become increasingly capable of generating convincing speech and text, the ability to distinguish between a user's authentic thoughts and AI-generated content that the user is reading becomes valuable for security, trust, and interaction quality. The user authenticity process 1000 analyzes multiple dimensions of the user's physiological signals to detect patterns that indicate authentic versus read speech, enabling the system to provide appropriate responses or alerts in different scenarios.

The user authenticity process 1000 begins by receiving pre-processed signals from the pre-processing module(s) 131, as in 1002. These pre-processed signals are the same signals used by the synthesis ML model(s) 350 to generate the output representation 222, and include data from the various sensors 112 that capture the user's physiological patterns during speech production. The pre-processed signals may include EMG data reflecting muscle activation patterns, EEG and fNIR data indicating neural activity, detection-and-ranging data showing micro-deformations in the ear canal, motion data from accelerometers and gyroscopes, and/or other sensor modalities that collectively provide rich information about how the user is producing the detected communication.

The system also receives an audio signal of user speech, as in 1004. This audio signal may be captured by acoustic sensors 112-3, such as MEMS microphones, and represents the vocalized speech that the user is producing. The audio signal provides acoustic information about the user's speech that complements the physiological data captured by the other sensor(s). In some implementations, the user authenticity process 1000 may be triggered when the user produces audible speech rather than inaudible communication, as the distinction between authentic and read speech is particularly relevant for scenarios where the user is speaking aloud, such as during video calls, interviews, presentations, or security verification procedures where confirming that the user is speaking their own authentic thoughts rather than reading from a script or repeating content generated by an AI system provides valuable security or trust information.

The system determines authenticity markers from the one or more sensor signals, as in 1006. These authenticity markers represent patterns in the physiological data that correlate with authentic speech production versus reading scripted content. The determination of authenticity markers may leverage the machine learning capabilities of the system, potentially using the ML model(s) 141 or specialized models trained to detect these patterns. The authenticity markers capture subtle differences in how individuals produce speech when expressing their own thoughts compared to when they are reading pre-written text or repeating content from memory.

The authenticity markers determined by the system may include eye movement patterns, which reflect differences in visual attention between authentic speech and reading. When a user is reading scripted content from a display or paper, their eye movements follow characteristic patterns of reading, including left-to-right scanning (in languages with left-to-right text direction), regular saccades between lines, and fixations on specific words or phrases. These reading-related eye movements can be detected through the electrical (ExG) sensors 112-2, particularly the EMG sensors that capture the electrical activity of the extraocular muscles that control eye movement. In contrast, when a user is speaking authentically without reading, their eye movements exhibit different patterns, such as more varied directions of gaze, fewer regular saccades, and different fixation patterns that reflect thinking and memory retrieval rather than reading.

The authenticity markers may also include eye blink rate, which tends to differ between authentic speech production and reading scripted content. Research in cognitive psychology has established that blink rates vary with cognitive load and the type of cognitive task being performed. Reading typically produces a different blink rate pattern than spontaneous speech production, as the visual processing demands and cognitive processes differ between these activities. The system detects eye blinks through the EMG sensors that capture the electrical activity of the orbicularis oculi muscle, which controls eyelid movement, enabling the system to compute blink rates and compare them against expected patterns for authentic versus read speech.

The authenticity markers may further include prosody, which refers to the rhythmic and intonational aspects of speech including pitch patterns, timing, rhythm, and stress patterns. Authentic spontaneous speech exhibits prosodic characteristics that differ from read speech. When individuals read scripted content, their speech often displays more monotonous intonation, more regular rhythm and timing, less natural pitch variation, and reduced emotional expressiveness compared to spontaneous authentic speech. The acoustic sensors 112-3 capture the audio signal from which prosodic features can be extracted and analyzed. The system analyzes the prosody of the user's speech to identify patterns characteristic of reading versus authentic spontaneous production.

The authenticity markers may also include emotion, which reflects the affective state of the user during speech production. The fNIR sensors 112-4 capture brain activity, for example in the temporal lobe, which is associated with emotional processing, and this neural activity provides information about the user's emotional state during communication. Authentic spontaneous speech typically exhibits stronger and more varied emotional responses that are reflected in brain activity patterns, while reading scripted content often shows diminished or absent emotional neural responses because the user is not generating the content from their own thoughts and feelings. The emotional authenticity markers derived from fNIR data can indicate whether the user's brain is engaged in emotional processing consistent with authentic communication or whether the emotional engagement is reduced consistent with reading someone else's content.

The system evaluates whether the user's speech is authentic based on the determined authenticity markers, as in 1008. This evaluation analyzes the patterns across the one or more authenticity markers to make a determination about whether the detected speech represents the user's authentic thoughts or whether the user is reading or repeating scripted content. The evaluation may use various decision-making approaches. For example, a rule-based approach might specify that certain combinations of marker patterns (such as reading-type eye movements combined with reduced emotional neural activity) indicate non-authentic speech. Alternatively, a machine learning-based approach might use a classifier trained on examples of authentic and read speech to make the authenticity determination based on the marker patterns.

If the speech is determined not to be authentic, the system outputs an indication that the user's speech is not authentic, as in 1012. This output may take various forms depending on the application context. In a security or verification scenario, the system might alert a security monitor or verification system that the user appears to be reading scripted content rather than speaking authentically, which might indicate an attempt to deceive or bypass security measures. In a communication scenario, the system might alert the recipient that the speaker may be reading prepared content, which provides transparency about the nature of the communication. In an AI interaction scenario, the system might modify its response behavior when it detects that the user is reading content, potentially treating such inputs differently from authentic user communications.

If the speech is determined to be authentic, the system outputs an indication that the user's speech is authentic, as in 1014. This positive authentication of speech authenticity can be valuable in various scenarios. In security contexts, confirming authentic speech provides assurance that the user is genuinely expressing their own thoughts rather than being coerced or manipulated into repeating someone else's words. In communication contexts, authentic speech indicators can build trust between parties by verifying that each participant is speaking their own mind. In AI interaction contexts, confirming authentic speech enables the system to respond with higher confidence that it is interacting with genuine user intent rather than responding to content that may have been generated by another AI system and merely read by the user.

The user authenticity process 1000 illustrated in FIG. 10 provides a technological capability that addresses emerging challenges in an era where AI-generated content is increasingly sophisticated and difficult to distinguish from human-generated content. By analyzing multiple physiological markers that reflect the cognitive and motor processes underlying speech production, the system can detect subtle patterns that differentiate authentic communication from reading or repeating scripted material. This capability enhances security by detecting potential spoofing or manipulation attempts, improves trust in communications by verifying speaker authenticity, and enables more appropriate system responses by distinguishing user-initiated communications from content that originates from other sources.

The drawings are primarily for illustrative purposes and are not intended to limit the scope of the subject matter described herein. The drawing is not necessarily to scale; in some instances, various aspects of the subject matter disclosed herein can be shown exaggerated or enlarged in the drawing to facilitate an understanding of different features.

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a processor, a field programmable gate array (FPGA), and/or an application specific integrated circuit (ASIC). Software modules (executed on hardware) can include instructions stored in a memory that is operably coupled to a processor and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

What is claimed is:

1. An apparatus, comprising:
a housing:
an electromyography (EMG) sensor coupled with the housing and configured to, at least:
detect micro-movements of at least one of a jaw or a tongue of a user during an inaudible communication of the user; and
produce EMG sensor data corresponding to the micro-movements; and
a detection-and-ranging system coupled with the housing and configured to, at least:
detect micro-deformations inside an ear of the user during the inaudible communication of the user; and
produce detection-and-ranging sensor data corresponding to the micro-deformations;
a pre-processing module coupled with the EMG sensor and the detection-and-ranging system and operable to, at least:
pre-process the EMG sensor data received from the EMG sensor and produce pre-processed EMG sensor data; and
pre-process the detection-and-ranging sensor data and produce pre-processed detection-and-ranging sensor data; and
at least one machine learning (ML) model configured to receive as input the pre-processed EMG sensor data and the pre-processed detection-and-ranging sensor data and produce an output representation of a content of the inaudible communication of the user.

2. The apparatus of claim 1, further comprising:
a functional near-infrared spectroscopy (fNIR) sensor coupled with the housing and configured to, at least:
detect image data of a brain of the user during the inaudible communication of the user; and
produce fNIR sensor data corresponding to the image data; and
wherein:
the pre-processing module is further operable to pre-process the fNIR sensor data received from the fNIR sensor and produce pre-processed fNIR sensor data; and
the at least one ML model is further configured to receive as additional input the pre-processed fNIR sensor data.

3. The apparatus of claim 1, wherein the housing is sized and shaped to be positioned at least partially within an ear canal of the user.

4. The apparatus of claim 1, wherein the detection-and-ranging system comprises at least one of:
a sound navigation and ranging (SONAR) component configured to detect micro-deformations by reflecting acoustic signals off at least one of a jaw, a tongue, or an inner ear of the user;
a radio detection and ranging (RADAR) component configured to detect micro-deformations using electromagnetic signals; or
an ultrasound component configured to capture detailed movements related to the inaudible communication.

5. A system, comprising:
a user-interface device, comprising:
a housing:
at least one sensor coupled with the housing and configured to detect physiological signals associated with an inaudible communication of a user and produce sensor data; and
a pre-processing module operable to pre-process the sensor data and produce pre-processed sensor data; and
at least one machine learning (ML) model communicatively coupled with the pre-processing module and configured to, at least:
receive as input the pre-processed sensor data; and
produce an output representation of a content of the inaudible communication of the user.

6. The system of claim 5, wherein:
the user-interface device further includes a network interface; and
the at least one ML model is disposed on a computing device remote from the user-interface device and communicatively coupled to the user-interface device via the network interface.

7. The system of claim 5, wherein the pre-processing module is disposed within the housing of the user-interface device.

8. The system of claim 5, further comprising:
a computing device remote from the user-interface device and communicatively coupled to the user-interface device via a network, the computing device including:
a processor; and
a memory coupled to the processor and storing an artificial intelligence (AI) agent configured to, at least:
receive the output representation of the content of the inaudible communication from the at least one ML model;
determine, based at least in part on the output representation, an action to be performed; and
cause the action to be performed.

9. The system of claim 5, wherein the at least one sensor comprises at least one of:
an electromyography (EMG) sensor configured to detect micro-movements of at least one of a jaw or a tongue of the user;
a functional near-infrared spectroscopy (fNIR) sensor configured to detect image data of a brain of the user;
a sound navigation and ranging (SONAR) sensor configured to detect fine-grained motion in an ear of the user or around the ear of the user;
a radio detection and ranging (RADAR) sensor configured to detect micro-deformations inside the ear of the user;
an optical motion tracking sensor configured to track movements inside the ear of the user;
an interferometry sensor configured to detect micro-deformations based on changes in light wave patterns;
an ultrasound sensor configured to capture inner ear movements or apply low-intensity focused ultrasound (LIFU) to a neural region of a brain of the user;
an otoacoustic emissions device configured to detect changes in the ear;
a microelectromechanical systems (MEMS) microphone configured to capture movements related to jaw and tongue actions;
an in-ear electroencephalography (EEG) sensor configured to record electrical activity from a brain of the user;
a superconducting quantum interference device (SQUID) configured to detect magnetic signals associated with neural activity; or
a magnetoencephalography (MEG) configured to detect magnetic signals associated with neural activity.

10. The system of claim 5, wherein the housing is sized and shaped to be positioned at least partially within an ear canal of the user.

11. The system of claim 5, wherein the housing is sized and shaped to be positioned at least partially around an outer portion of an ear of the user.

12. The system of claim 5, further comprising:
an identity authenticator agent configured to, at least:
compare at least a portion of the pre-processed sensor data with stored user profile data associated with the user to authenticate an identity of the user; and
generate an authentication result indicating that the user is authenticated.

13. The system of claim 5, further comprising:
a translation agent configured to, at least:
receive at least a portion of the output representation; and
generate a translated output in a different language than a language of the output representation.

14. The system of claim 5, further comprising:
at least one output device configured to provide feedback to the user, the at least one output device comprising at least one of:
a speaker configured to provide audible feedback;
a haptic device configured to provide haptic feedback; or
a display interface configured to provide visual feedback.

15. The system of claim 5, wherein the at least one ML model comprises:
a plurality of sensor-specific ML models, each configured to process pre-processed sensor data from a corresponding sensor type; and
a synthesis ML model configured to, at least:
receive outputs from each of the plurality of sensor-specific ML models; and
produce, based at least in part on the outputs received from each of the plurality of sensor-specific ML models, the output representation.

16. An apparatus, comprising:
a wearable housing configured to be positioned around, on, or within an ear of a user;
a plurality of sensors coupled with the wearable housing and configured to generate sensor data corresponding to an inaudible communication generated by the user; and
at least one machine learning (ML) model configured to, at least:
receive as input the sensor data; and
produce an output representation corresponding to a content of the inaudible communication of the user.

17. The apparatus of claim 16, wherein the plurality of sensors comprises:
an electromyography (EMG) sensor configured to detect micro-movements of at least one of a jaw, a tongue, or vocal tract muscles of the user during the inaudible communication; and
a sound navigation and ranging (SONAR) sensor configured to detect fine-grained motion in an ear of the user or around the ear of the user;
a radio detection and ranging (RADAR) sensor configured to detect micro-deformations inside the ear of the user during the inaudible communication; or
an optical sensor configured to capture optical data to detect movements in the ear of the user or around the ear of the user during the inaudible communication.

18. The apparatus of claim 16, wherein the plurality of sensors further comprises:
a functional near-infrared spectroscopy (fNIR) sensor configured to produce image data of a brain of the user during the inaudible communication.

19. The apparatus of claim 16, further comprising:
at least one output device coupled with the wearable housing and configured to provide feedback to the user based at least in part on the output representation, the at least one output device comprising at least one of:
a speaker configured to provide audible feedback corresponding to the content of the inaudible communication; or
a haptic device configured to provide tactile feedback indicating confirmation or rejection of the output representation; and
a motion sensor configured to detect a head movement of the user indicating a confirmation or a rejection of the output representation.

20. The apparatus of claim 16, further comprising:
an identity authenticator component configured to, at least:
analyze patterns within the sensor data corresponding to characteristics unique to the user;
compare the patterns with stored profile data associated with the user; and
generate, based at least in part on the comparison, an authentication result indicating whether the user is authenticated;
wherein the at least one ML model is configured to produce the output representation only when the authentication result indicates that the user is authenticated.
